(19) United States
(12) Patent Application Publication
(10) Pub. No.: US 2013/0313199 A1
(43) Pub. Date: Nov. 28, 2013

(54) SYSTEM AND METHOD FOR TREATMENT OF PRODUCED WATERS

(71) Applicant: HIGH SIERRA ENERGY, LP, Denver, CO (US)

(72) Inventors: Mark A. Marcin, Pine, CO (US); Thomas R. Sage, Golden, CO (US)

(73) Assignee: High Sierra Energy, LP, Denver, CO (US)

(21) Appl. No.: 13/833,530

(22) Filed: Mar. 15, 2013

Related U.S. Application Data
(60) Provisional application No. 61/665,185, filed on Jun. 27, 2012.
(60) Provisional application No. 61/650,870, filed on May 23, 2012.

(51) Int. Cl. C02F 9/00

(52) U.S. Cl. CPC C02F 9/00
USPC 210/663; 210/182

(57) ABSTRACT

The systems and methods disclosed herein process produced/flowback water, such as high total dissolved solids produced water, to generate high purity, high value products with little to no waste. The generated high purity, high value products include caustic soda, hydrochloric acid, and/or sodium hypochlorite. Further, the methods and systems disclosed herein generate high quality brine for electrolysis through the systematic removal of contaminants such as but not limited to suspended solids, iron, sulfides, barium, radium, strontium, calcium, magnesium, manganese, fluoride, heavy metals, organic carbon, recoverable hydrocarbons, silica, lithium, and/or nitrogen containing compounds. Further, some products generated by the systems and methods disclosed herein may be recovered and reutilized or sold for other uses, such as carbon dioxide, calcium oxide, chlorine, magnesium oxide, calcium carbonate, and barium sulfate.

### RELATED APPLICATIONS

This application claims the benefit of U.S. Provisional Application No. 61/650,870, filed May 23, 2012, and entitled “System and Method for Treatment of Produced Waters” and the benefit of U.S. Provisional Application No. 61/665,185, filed Jun. 27, 2012, and entitled “System and Method for Treatment of Produced Waters”, which applications are hereby incorporated herein by reference.

### INTRODUCTION

The drilling of natural gas and oil wells continues to expand throughout the United States. While drilling continues to evolve and change, the one constant is the production of large amounts of contaminated water.

Typically, oil and gas exploration and production results in the extraction of a significant amount of subsurface water, called produced water, along with the hydrocarbon. The produced water contains contaminants from mineral deposits obtained far beneath the earth's surface. For example, the contaminants may include, but are not limited to, suspended solids and scale forming compounds such as sodium, chloride, iron, calcium, magnesium, barium, strontium and/or residual petroleum hydrocarbons.

### Treatment of Produced Waters

The systems and methods disclosed herein process produced water, such as high total dissolved solids (TDS) produced water, to generate high purity, high value products with little to no waste. The generated high purity, high value products include caustic soda, hydrochloric acid, and/or sodium hypochlorite. Further, the methods and systems disclosed herein generate high quality brine for electrolysis through the systematic removal of contaminants such as but not limited to suspended solids, iron, sulfides, barium, radium, strontium, calcium, magnesium, manganese, fluoride, heavy metals, organic carbon, recoverable hydrocarbons, silica, lithium, and/or nitrogen containing compounds. Further, some products generated by the systems and methods disclosed herein may be recovered and reutilized or sold for other uses, such as carbon dioxide, calcium oxide, chlorine, magnesium oxide, calcium carbonate, and barium sulfate.

In part, this disclosure describes a system for treating contaminated water to produce at least one of sodium hydroxide, hydrochloric acid, and sodium hypochlorite. The system includes:

a first coagulation tank configured to oxidize and coagulate effluent from waste water influent;

a first pH adjustment tank configured to adjust a pH of effluent from the first coagulation tank;

a first floc mix tank configured to add a first flocculant to effluent from the first pH adjustment tank;

an iron clarifier configured to separate iron from effluent from the first floc mix tank;

a second pH adjustment tank for adjusting the pH of effluent from the iron clarifier;

at least one multimedia filter configured to filter effluent from the second pH adjustment tank;

a first organics removal system configured to remove at least petroleum hydrocarbons from effluent from the at least one multimedia filter;

a first heat exchanger configured to heat effluent from the first organics removal system;

a third pH adjustment tank configured to adjust the pH of effluent from the first heat exchanger;

a softening clarifier configured to remove calcium carbonate and magnesium hydroxide sludge from effluent from the third pH adjustment tank;

a weak acid cation ion exchange column and a chelating ion exchange column configured to remove any remaining calcium and remaining magnesium to a level of less than 50 ppb from effluent from the softening clarifier;

a fourth pH adjustment tank configured to adjust the pH of effluent from the weak acid cation ion exchange column and the chelating ion exchange column;

a second floc mix tank configured to add a second flocculant to effluent from the fourth pH adjustment tank;

an aluminum clarifier configured to remove aluminum from effluent from the second floc mix tank.

a fifth pH adjustment tank configured to adjust the pH of effluent from the aluminum clarifier;

a membrane system configured to allow transport of ammonium ions across a semipermeable membrane into a cross flowing solution containing sulfuric acid to remove ammonium from effluent from the fifth pH adjustment tank;

an ammonia stripping tower configured to remove remaining ammonia from effluent from the membrane system;

a sixth pH adjustment tank configured to adjust the pH of effluent from the ammonia stripping tower;

a polishing tank configured to remove fluoride with using activated alumina from effluent from the sixth pH adjustment tank;

a filter configured to remove colloidal solids from effluent from the polishing tank;

a second organics removal system configured to remove at least one of organic acid and alcohol from effluent from the filter;

an evaporative brine concentrator configured to concentrate effluent from the second organics removal system, wherein effluent from the evaporative brine concentrator is a concentrated purified brine;

at least one electrolysis unit configured to convert the concentrated purified brine into at least one of sodium hydroxide, hydrochloric acid, and sodium hypochlorite.

The system for treating contaminated water does not form any waste product that requires disposal in an EPA regulated Class II disposal well.

Additionally, the disclosure describes a method for producing at least one of sodium hydroxide, hydrochloric acid, and sodium hypochlorite from contaminated water. The method includes:

removing iron from influent water to produce an iron reduced effluent;

removing petroleum hydrocarbons from the iron reduced effluent to produce a an organics reduced effluent;

removing at least one of calcium and magnesium from the organics reduced effluent to produce a softened effluent;

removing aluminum from the softened effluent to produce a clarified effluent;

removing ammonia from the clarified effluent to produce a purified brine;

treating the purified brine with cation and ion exchange resins to form a scale ion free brine;

polishing the scale ion free brine to produce a polished brine;

removing at least one of organic acid and alcohol from the polished brine to produce an organics reduced brine;

evaporating the organics reduced brine to produce a concentrated brine; and

treating the concentrated brine with electrolysis to produce at least one of sodium hydroxide, hydrochloric acid, and sodium hypochlorite.

Further, the disclosure describes a system for treating contaminated water to produce at least one of sodium hydroxide, hydrochloric acid, and sodium hypochlorite. The system includes:

a separated solids and iron removal system;

a first organics removal system adapted to remove at least petroleum hydrocarbons located downstream of the separated solids and iron removal system;

a soda softening system located downstream of the first organics removal system;

an aluminum removal system located downstream of the soda softening system;

an ammonia removal system located downstream of the aluminum removal system;

a polishing system located downstream of the ammonia removal system;

a second organics removal system adapted to remove at least one of organic acid and alcohol located upstream of a brine evaporation system and downstream from the first organics removal system;

the brine evaporation system located downstream of the polishing system and the second organics removal system; and

an electrolysis system located downstream of the brine evaporation system.

The system is configured to produce at least one of sodium hydroxide, hydrochloric acid, and sodium hypochlorite.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments of systems and methods described below and are not meant to limit the scope of the invention in any manner, which scope shall be based on the claims.

The following drawing figures, which form a part of this application, are illustrative of embodiments of systems and methods described below and are not meant to limit the scope of the invention in any manner, which scope shall be based on the claims.

FIGS. 1A-1F illustrate an embodiment of a water treatment system for treating contaminated water to produce sodium hydroxide, hydrochloric acid, and/or sodium hypochlorite from purified brine according to the principles of the present disclosure.

FIG. 1A illustrates an embodiment of an oil removal and recovery system and an iron removal system, a first organics removal system, a strontium removal system, and a portion of a barium and strontium removal system.

FIG. 1B illustrates an embodiment of a portion of the barium removal system, a soda softening system, an aluminum removal system, a lithium removal system, an ammonia removal system, an ion and cation exchange system, and a portion of the polishing system in the water treatment system according to the principles of the present disclosure.

FIG. 1C illustrates an embodiment of a portion of a polishing system, a brine purification system, a second organics removal system, a brine evaporation system, and an electrolysis system in the water treatment system for treating contaminated water according to the principles of the present disclosure.

FIG. 1D illustrates an embodiment of downstream processing systems for removed barium sludge, recovered oil, and produced chlorine gas in the water treatment system for treating contaminated water according to the principles of the present disclosure.

FIG. 1E illustrates an embodiment of downstream processing systems for removed iron sludge, produced sodium hydroxide, produced hydrochloric acid, produced sodium hypochlorite, and removed lithium sludge in the water treatment system for treating contaminated water according to the principles of the present disclosure.

FIG. 1F illustrates an embodiment of downstream processing systems for removed calcium carbonate sludge in the water treatment system for treating contaminated water according to the principles of the present disclosure.

FIG. 2 illustrates an embodiment of a method for treating water.

FIGS. 3A-3D illustrates an embodiment of a water treatment system for treating contaminated water to produce sodium hydroxide, hydrochloric acid, and/or sodium hypochlorite from purified brine according to the principles of the present disclosure.

### DETAILED DESCRIPTION

Unless otherwise indicated, all numbers expressing quantities of ingredients, properties such as molecular weight, concentrations, reaction conditions, temperatures, and so forth used in the specification and figures are to be understood as being modified in all instances by the term “about.” Accordingly, unless indicated to the contrary, the numerical parameters set forth in the following specification and figures are approximations that may vary depending upon the desired properties sought to be obtained. At the very least, and not as an attempt to limit the application of the doctrine of equivalents to the scope of specification and figures, each numerical parameter should at least be construed in the light of the number of reported significant digits and by applying ordinary rounding techniques.

When referring to concentrations of contaminants in water or to water properties such as pH and viscosity, unless otherwise stated the concentration refers to the concentration of a sample properly taken and analyzed according to standard Environmental Protection Agency (EPA) procedures using the appropriate standard test method or, where no approved method is available, commonly accepted methods may be used. For example, for Oil and Grease the test method identified as 1664A is an approved method. In the event two or more accepted methods provide results that indicate two different conditions as described herein, the condition should be considered to have been met (e.g., a condition that must be “above pH of about 7.0” and one accepted method results a pH of 6.5 and another in pH of 7.2, the water should be considered to be within the definition of “about 7.0”).

The level of contamination for produced water varies with geography and shale basins. For example, the Bakken, Marcellus, and Utica contain some of the most contaminated produced waters. These produced waters typically contain high total dissolved solids (TDS) in excess of 150,000 mg/l primarily as sodium chloride. Treatment for disposal by discharge to a river system under the regulations of a National Pollution Discharge Elimination System (NPDES) permit has diminishing returns. Due to the starting concentration of salt in these waters, thermal evaporation systems may only be able to recover 40-50% of the incoming volume as high quality distillate suitable for discharge. To generate this high quality distillate, requires significant pretreatment and removal of scale forming salts such as calcium. This requirement only acts to increase the cost of evaporation technology. The result is a small volume reduction of up to 40-60% and the reality of having to dispose of highly concentrated brine containing over 260,000 mg/l sodium chloride. Disposal of this brine in an EPA regulated Class II disposal well is the only remaining option. This disposal methodology may require transportation of the concentrated waste long distances by truck, sometimes to a neighboring state. The cost to truck this water then becomes a significant burden to energy and petroleum (E&P) companies and could eventually restrict further exploration in these rich natural resource but high TDS basins.

Accordingly, The systems and methods disclosed herein process produced water, such as high TDS produced water, to generate high purity, high value products with little to no waste. The generated high purity, high value products include caustic soda, hydrochloric acid, and/or sodium hypochlorite. Further, the methods and systems disclosed herein generate high quality brine for electrolysis through the systematic removal of contaminants such as but not limited to suspended solids, iron, sulfides, barium, radium, strontium, calcium, magnesium, manganese, fluoride, heavy metals, organic carbon, recoverable hydrocarbons, silica, methanol, lithium, and/or nitrogen containing compounds. Further, some products generated by the systems and methods disclosed herein may be recovered and reutilized or sold for other uses, such as carbon dioxide, calcium oxide, chlorine, magnesium oxide, calcium carbonate, iron chloride, hydrogen gas, and barium sulfate. If there is any produced waste, the waste can be disposed through conventional and non-conventional disposal methods and/or systems.

Therefore, the systems and methods disclosed herein provide for an environmentally friendly process since several of the compounds added are regenerated during later downstream processing. Further, the systems and methods disclosed herein process the water to an extent that none of treated water or resulting products are labeled as EPA regulated Class II, which requires specific disposal wells. The elimination of contaminated water labeled as EPA regulated Class II also in turn reduces the costs of disposal. Further, the generation of high purity products allows these products to be sold and/or reutilized reducing environmental effects and/or reducing treatment costs.

The high TDS waters from basins such as the Bakken, Marcellus, and Utica shale's can be processed with systems and methods disclosed herein, which utilizes almost 100% of the produced water generated and received at a treatment facility as raw material for the manufacture of products which can be sold into markets both in the United States and abroad. The systems and method disclosed herein are not limited to those basins which exhibit high TDS produced waters. The disclosed systems and methods could be applied to any produced water that has been concentrated through various treatment technologies such as reverse osmosis, forward osmosis, membrane evaporation or thermal evaporation systems.

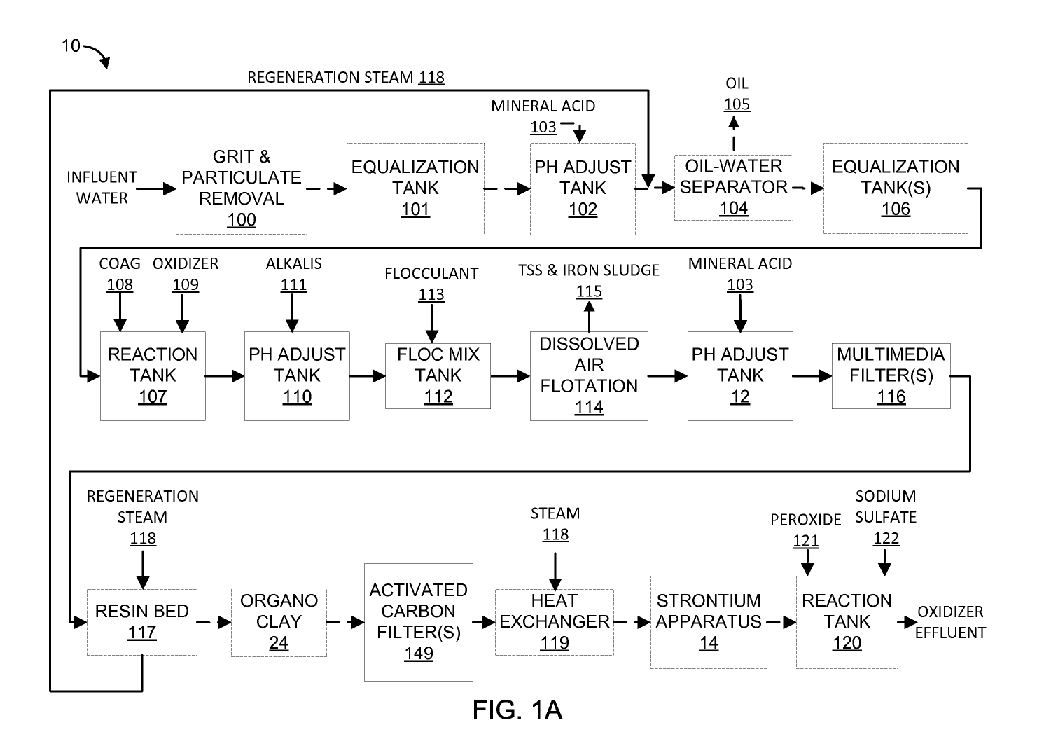

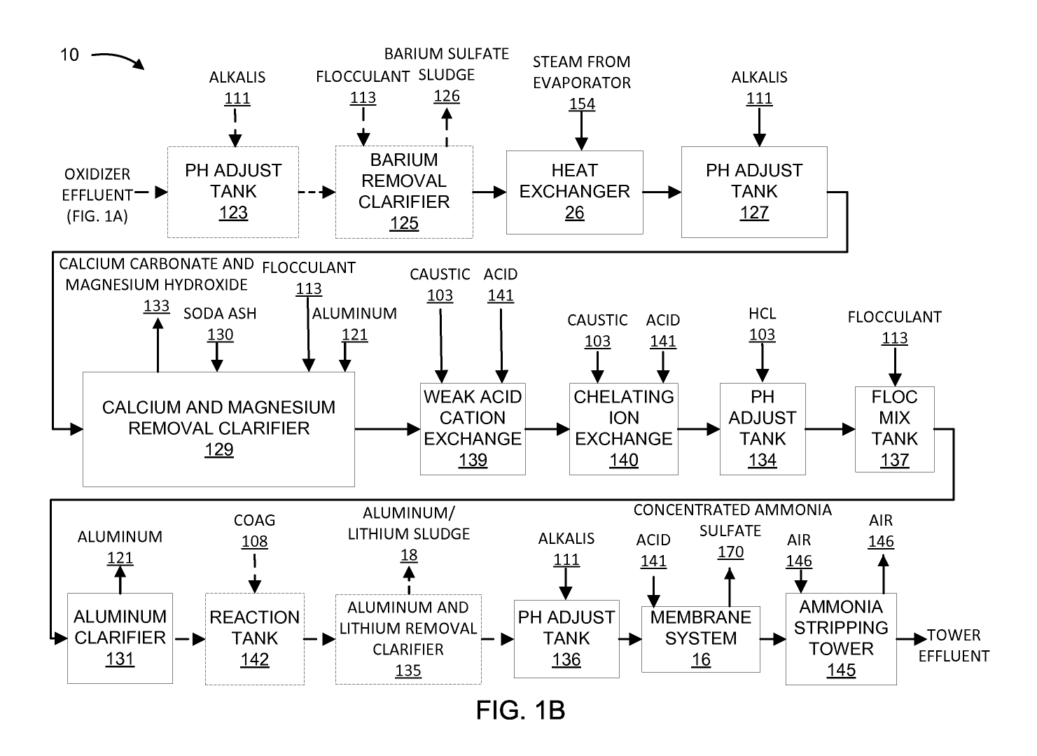

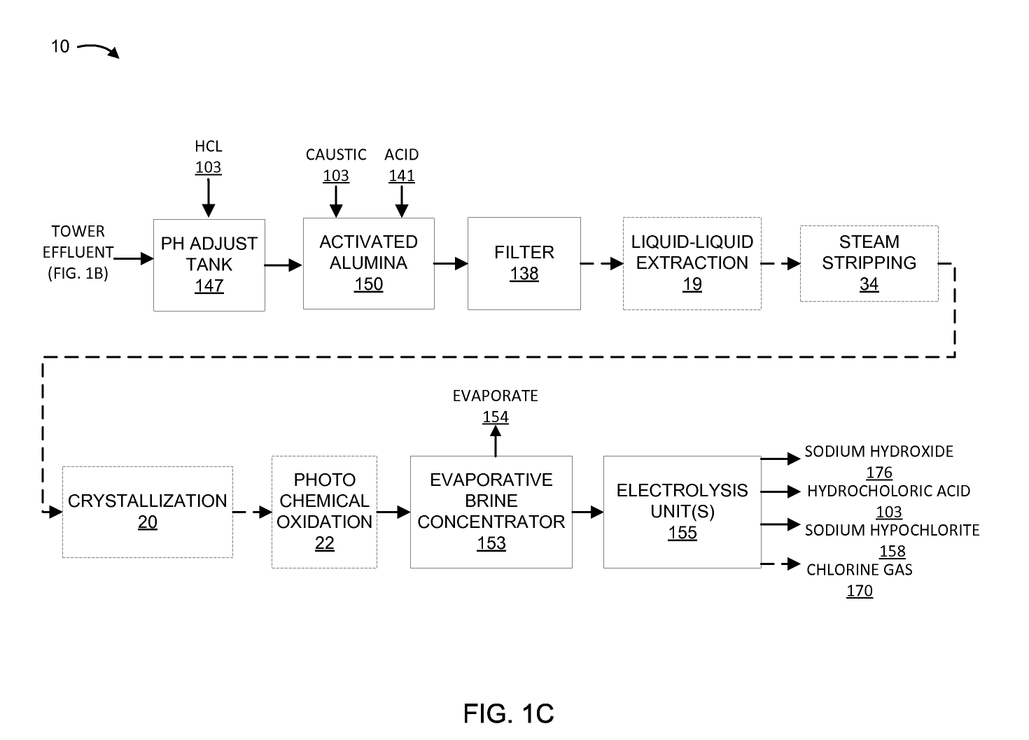

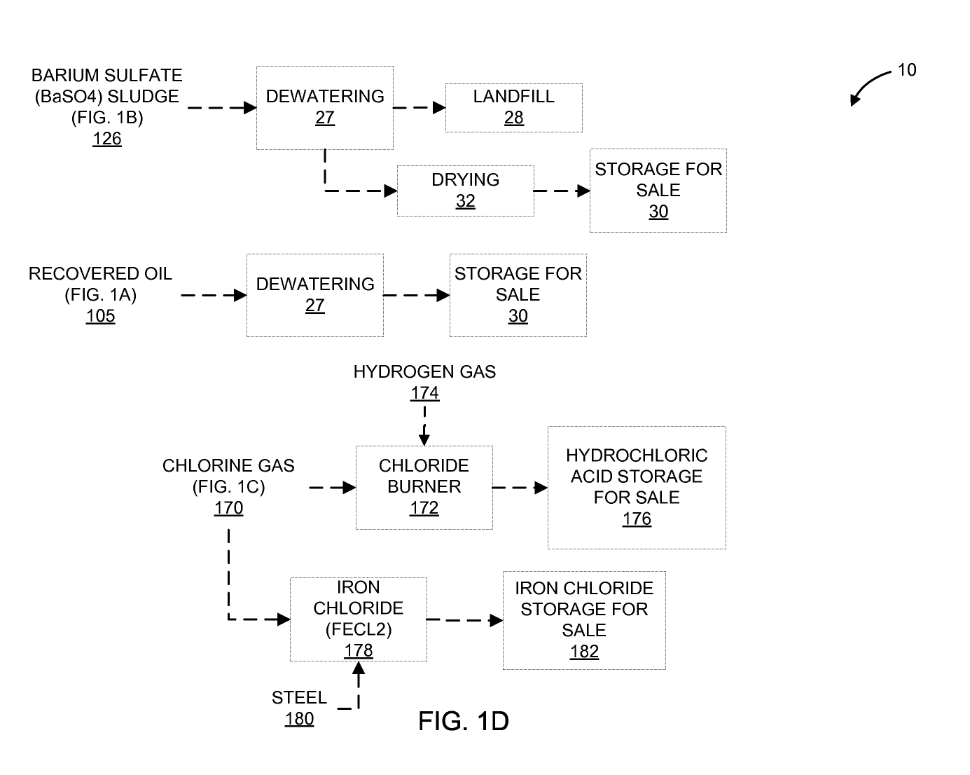

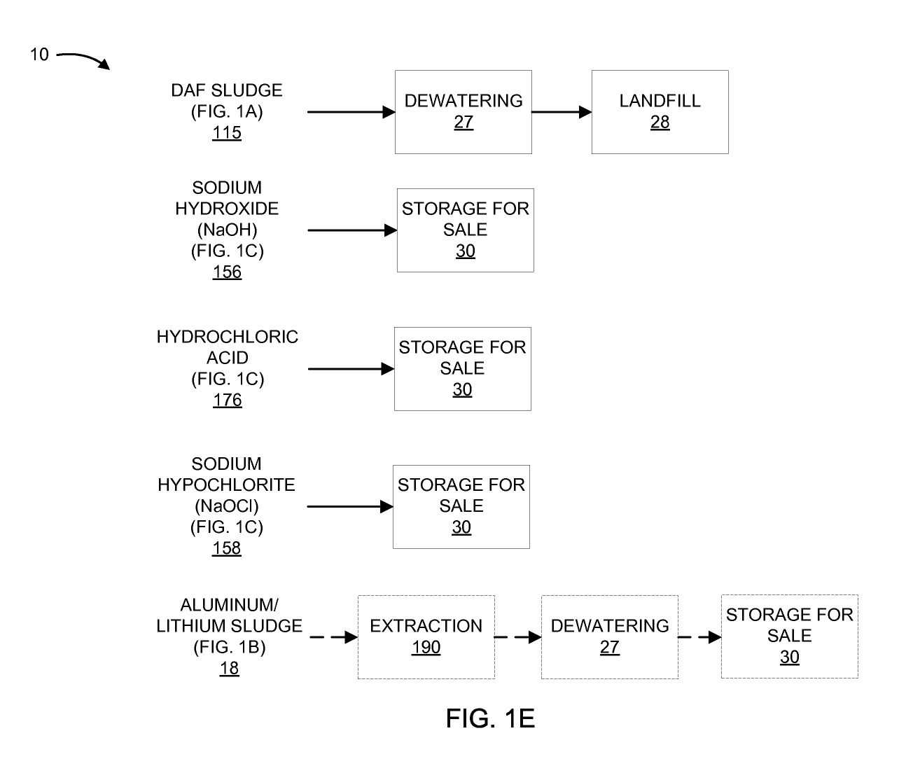

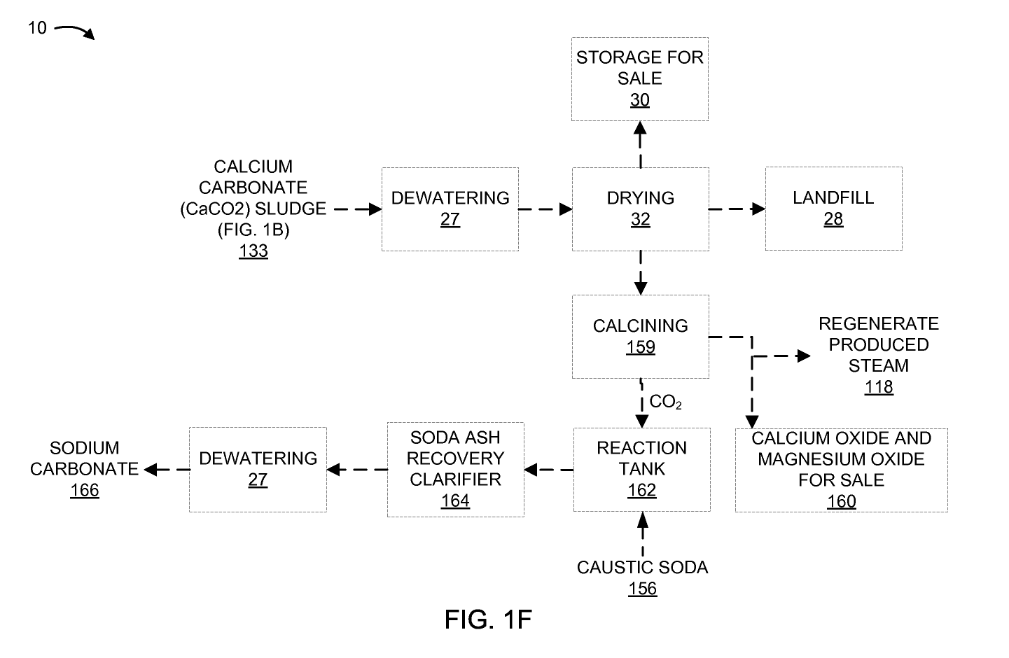

FIGS. 1A-1F illustrates a system 10 for processing produced water. As illustrated in FIG. 1A, the flowback/produced water is input into the system 10. In some embodiments, the flowback/produced water arrives by truck. In other embodiments, the flowback/produced water arrives by pipeline. In one embodiment, the produced water or influent water contains greater than 100,000 mg/L of TDS. This concentration of TDS is exemplary only and produced water with other concentrations of TDS may be treated by system 10. In some embodiments, the flowback/produced water input into system 10, prior to treatment with system 10 would require disposal in an EPA regulated Class II disposal well. None of the products or effluent water produced from system 10 require disposal in an EPA regulated Class II disposal well.

In some embodiments, the flowback/produced water is mechanically screened using wastewater screening equipment 100 such as hydrosieves, semi-automatic backwashing filters and rotary screens to form screened water. This screening removes large particulates which may affect the pumping equipment downstream. Any suitable screening method for treating the produced water may be utilized by system 10.

In some embodiments, the screened water from the waste water screening equipment 100 or the flowback/produced water is input into one or more surge tanks 101 to form equalized produced/flowback water. The surge tank 101 compensates for flow variations caused by numerous trucks unloading at any given time.

In embodiments where oil is removed from the flowback/produced water, the screened water, the flowback/produced water, and/or the equalized produced/flowback water is input or transferred to a pH adjustment tank 102 whereby the pH is depressed to about 4-5 using a mineral acid 103. In some embodiments the mineral acid 103 is hydrochloric or sulfuric acid 141. The pH reduction accentuates the removal of oils or hydrocarbons in downstream equipment. The pH may be adjusted using any conventional means, such as through the addition of mineral acids (e.g., hydrochloric and sulfuric acids) or by adding carbon dioxide gas. In some embodiments, the mineral acid 103 is hydrochloric acid 157 produced by a downstream electrolysis unit 155. In other embodiments, the mineral acid 103 is purchased.

In some embodiments, the pH adjusted produced/flowback water from the pH adjustment tank 102 is pumped into a coalescing oil/water separator 104 to form produced/flowback water containing only water soluble oil and petroleum hydrocarbons 105 and trace C20 hydrocarbons. In embodiments, where the produced/flowback water does not contain any or very little oil, the oil removal and reduction system including the coalescing oil/water separator 104 and the pH adjustment tank 102 are not utilized. The separator 104 removes hydrocarbons with carbon chain lengths of greater than C20 and droplet sizes greater than 20 microns also known. Any coalescing oil/water separator 104 as known in the art may be utilized by system 10. In some embodiments, the removal efficiency of this droplet size is greater than 95%. In addition, lower chain petroleum hydrocarbons 105 which are at a concentration in the water that exceeds the solubility of that contaminate in water will be removed at this point. For example, the water solubility of benzene is 1780 mg/l; therefore, any concentrations of benzene above this concentration are separated, due to specific gravity differential, out of the water and are easily removed by the oil/water separator 104. The oil and petroleum hydrocarbons 105 are separated from the pH adjusted produced/flowback water and then removed. In some embodiments, the removed oil and petroleum hydrocarbons 105 are dewatered utilizing a dewater system 27 and then pumped to storage tanks 30 for resale as illustrated in FIG. 1D. Any suitable dewatering system 27 may be utilized, such as a centrifuge.

In some embodiments, the produced/flowback water containing only water soluble petroleum hydrocarbons 105 and trace C20 hydrocarbons from the oil and water separator 104 flows into an equalization tank 106. In other embodiments, the grit removed water from the waste water screening equipment 100 flows into an equalization tank 106. In some embodiments, multiple equalization tanks 106 are utilized. In embodiments, an equalization tank 106 is capable of storing a production volume equal to approximately 1 day of treatment based upon facility design. Equalization tanks may be added throughout system 10 as needed or as desired.

The pH adjusted produced/flowback water from the pH adjustment tank 102, the produced/flowback water containing only water soluble petroleum hydrocarbons 105 and trace C20 hydrocarbons from the oil and water separator 104, or the equalized produced/flowback water from the equalization tank 106 is transferred to a coagulation tank 107 where a small amount of oxidizer 109, such as but not limited to hydrogen peroxide, sodium hypochlorite 158, chlorine dioxide, sodium persulfates and permanganates, is added. In some embodiments, sodium hypochlorite 158 is added because sodium hypochlorite 158 is generated in the downstream electrolysis unit 155, such as during start-up and shut down. This coagulation tank 107 oxidizes ferrous iron to ferric iron and sulfides to sulfates. The equalized produced/flowback water from the coagulation tank 107 is also treated with a coagulant 108. The coagulant 108 may be any inorganic coagulant 108 containing iron or aluminum 121. In some embodiments, the coagulant 108 may be organic coagulants such as polyamines and poly-DADMCs.

Coagulated water from the reaction tank or coagulation tank 107 flows into pH adjustment tank 110 where the pH is again adjusted to a pH of 6.5-7.5 using alkalis 111 such as caustic soda 156, potassium hydroxide, sodium carbonate 166, lime, and magnesium hydroxide. In some embodiments, the alkalis 111 is a caustic soda 156 produced by the downstream electrolysis unit 155. In other embodiments, the alkali 111 is a caustic soda 156 that is purchased. In some embodiments, sodium based alkalis 111 are utilized since the use of sodium based alkalis 111 contribute to the conversion back to caustic soda 156 in the downstream electrolysis unit 155.

The pH adjusted water from the pH adjustment tank 110 is then treated with a flocculant 113 in floc mix tank 112. The flocculated produced water from the floc mix tank 112 flows into a solids/liquid separation system 114. In some embodiments, the solids/liquid separator 114 is a gravity and or an air floatation system, such as a dissolved air flotation system (DAF), known to those skilled in the art.

In some embodiments, the flocculated or separated solids 115 from the solids/liquid separation system 114 pass into a filtration system which may consist of a multimedia filter or a membrane system. The separated solids 115 may also be subject to end processing as illustrated in FIG. 1E. For example, the separated solids 115 are dewatered. The separated solids 115 may mainly include iron hydroxides and iron carbonates. The separated solids 115 may be dewatered by utilizing a dewatering system 27. Any suitable dewatering system 27 or methods as known to those skilled in the art for dewatering may be utilized. After dewatering, the separated solids may be transported to a landfill 28 for disposal. In some embodiments, filtrate from the dewatering process is sent back to the beginning of system 10 for reprocessing.

The water from the solids/liquid separator 114 is then sent to another pH adjustment tank 12, whereby the pH is depressed again to about 4-6.5 using a mineral acid 103. In some embodiments the mineral acid is hydrochloric or sulfuric acid 141. The pH reduction accentuates the removal of total organic carbon (TOC) in downstream equipment. The pH may be adjusted using any conventional means, such as through the addition of mineral acids (e.g., hydrochloric and sulfuric acids) or by adding carbon dioxide gas. In some embodiments, the mineral acid 103 is hydrochloric acid 157 produced by a downstream electrolysis unit 155. In other embodiments, the mineral acid 103 is purchased. Unexpectedly, the removal of TOC varied. Upon investigation it was found that the manipulation of the pH after the solids separation by solids/liquid separation system 114 maximized TOC reduction. Accordingly, pH adjustment tank 12 was added to system 10 to maximize TOC reduction.

The first organics removal system includes a pH adjust tank 12, filter 116, and TOC removal system. The pH adjusted water from the pH adjustment tank 12 is then sent through one or more filters 116. In some embodiments, the filter 116 is a multimedia filter or equivalent. In other embodiments, the filter 116 is a membrane filter, sand filter, and/or bag filter. The filtered water from the filter 116 is then passed through a TOC removal system where petroleum hydrocarbons in the gasoline, diesel, and oil range are adsorbed.

In some embodiments, the TOC removal system is a resin bed 117, such as a Dow Optipore L493® resin bed as sold by the Dow Chemical Company headquartered at 2030 Dow Center, Midland, Mich. 48674. The resin in the resin bed 117 acts as an absorbent for organics lowering the overall total organic carbon (TOC) footprint of this water. The resin, such as an Optipore resin, may be regenerated with steam 118. In some embodiments, the steam is supplied by a facilities boiler system. After regeneration, the steam is condensed through cooling. In some embodiments, the condensate from the resin bed 117 is separated into two phases allowing recovery of the petroleum hydrocarbons. In further embodiments, the separated condensate or steam 118 is transferred to the oil storage tank. The stored hydrocarbons are suitable for resale.

The Dow resin from the Dow Optipore L493 resin bed provides several benefits. For example, the Dow resin from the Dow Optipore L493 resin bed has a high surface area and a more widely distributed pore size than activated carbon and offers the benefit of onsite regeneration with steam and high absorption capacity. Further, the absorption capacity of the Dow resin is estimated at 21% w/w meaning 100 pounds of Dow resin could absorb 21 pounds of total petroleum hydrocarbons (TPH). Additionally, the Dow resin requires 5 pounds of steam per pound of TPH removed for regeneration.

The Optipore L493 resin has shown to be able to reduce TOC from 225 mg/l to 140 mg/l as well as removal of BTEX of up to 99.98%. TOC removal is totally dependent upon the characteristic make-up of the organics in the produced/flowback water. BTEX removal has been documented down to the low ppb level.

However, when the produced/flowback water has low levels of recoverable hydrocarbons, the TOC removal system may be an organo-clays 24. The organo-clay 24 can be utilized to adsorb organics or TOC instead of utilizing a resin bed 117. For example, an organo clay, such as Hydrosil HS-200® as sold by Hydrosil International Ltd. Located at 1180 St. Charles Street, Elgin, Ill. 60120, has been found to adsorb up to 70% of its weight in oils and BTEX. The organo clay material is generally not regenerated. Accordingly, once the organo clay reaches absorption capacity, the resin is removed and disposed in a secure landfill. The disposed resin will pass all EPA Toxicity Characteristic Leaching Procedure tests.

The water with reduced TOC from the organic removal system is then pumped into one or more activated carbon columns 149 for polishing and removal of trace contaminants, such as iodine and some metals. Some organic substances will be removed in this step to continue to reduce the TOC. In some embodiments, depending on the influent concentration of iodine, activated carbon may be used to recover and recycle the iodine for resale. In some embodiments, the activated carbon columns 149 and the organo-clay system 24 are combined.

In some embodiments, water from the one or more activated carbon columns 149 is heated as illustrated in FIG. 1A. The water may be heated to about 90-120 degrees Fahrenheit to accelerate the rate of reaction in the reaction tank 120. In some embodiments, water is heated by using a plate and frame or shell in tube heat exchanger 119 with the source of heat being the condensate or the high quality distillate 154 generated by the downstream evaporation system 153 located downstream of these components. In some embodiments, the temperature may be increased beyond 120 degrees to further enhance the reaction.

In some embodiments, the heated water or the water from the one or more activated carbon columns 149 from the first organics removal system is run through a strontium removal apparatus 14. The strontium removal apparatus 14 removes strontium from the heated water or the water from the one or more activated carbon columns 149. In some embodiments, the strontium removal apparatus 14 is a strontium specific ion exchange resin. For example, iron oxide coated sand may be utilized to reduce the levels of strontium in the heated water or the water from the one or more activated carbon columns 149. The strontium removal apparatus 14 is designed to create an effluent with less than 0.1% strontium. In some embodiments, the heated water or the water from the one or more activated carbon columns 149 has a concentration of strontium of about 5%. However, this level of strontium is exemplary only and will vary based on the produced/flowback water treated by the system 10.

The level of the strontium in the produced/flowback water was higher than expected. Accordingly, the barium solids/liquid separator 125 did not remove enough strontium for the sale of some downstream products. For example, the removal of the strontium from the heated water or the water from the one or more activated carbon columns 149 is particularly useful in the sale of calcium carbonate. For example, some vendors will only purchase calcium carbonate if the levels of strontium are below 0.1%. For instance, while calcium carbonate with levels of strontium of around 5% may be sold for use in concrete, other vendors that use calcium carbonate as a neutralizer in acid mine drainage or as an acid gas neutralizer in coal burning power plants require a strontium level of below 0.1%. In some embodiments, for every 1 mg/l strontium in the water 1.62 mg/l of sodium sulfate or 1.119 mg/l sulfuric acid is utilized for the removal of the strontium. While the FIG. 1A shows the strontium removal apparatus 14 downstream from the organics removal system, the strontium removal apparatus 14 may be located before the solids liquid separator 129 or before the solids/liquid separator 125.

In embodiments where barium is removed from the influent water, the water for the organics removal system, the heated water or the water from the strontium removal apparatus 14 flows into another reaction tank 120. Sulfuric acid 141 and/or sodium sulfate 122 are added to the reaction tank 120 at or near a stoichiometric amount to precipitate barium. In some embodiments, the sulfuric acid 141 and/or sodium sulfate 122 are added to the reaction tank 120 at or near a stoichiometric amount to precipitate out additional or remaining strontium as sulfates in addition to the barium. In some embodiments, sodium sulfate 122 is utilized because sodium sulfate 122 produces lower barium residual and does not require vast amounts of caustic soda 156 for neutralization when compared to other precipitating reagents like sulfuric acid. This reaction is conducted under acidic conditions and in some embodiments, a high concentration of an oxidizer 109 is added. The oxidizer 109 may be, but is not limited to, hydrogen 174 peroxide, sodium or potassium permanganates, sodium or potassium persulfates, ozone and/or other advanced oxidation technologies known to those skilled in the art. Further, in some embodiments, the addition of an oxidizer 109 further oxidizes some of the residual petroleum hydrocarbons 105 and reduces total organic carbon (TOC). For example, potassium permanganate has demonstrated TOC removals up to 50% on some samples of Marcellus produced waters. In some embodiments, the contact time in this step is less than 30 minutes.

In embodiments, where barium is removed from the influent water, the water from reaction tank 120 then flows into another pH adjustment tank 123 where caustic soda 156 or other alkalis 111 such as magnesium hydroxide, calcium hydroxide, and/or potassium hydroxide are added to raise the pH to a neutral level. In some embodiments, every 1 mg/l Barium in the water requires the addition of 1.034 mg/k sodium sulfate or 0.714 mg/l sulfuric acid.

This pH adjustment is beneficial for following solids/liquid separation steps, such as flocculation. In some embodiments, the alkalis 111 are sodium based alkalis since sodium alkalis eventually convert to caustic soda 156 during downstream electrolysis by the electrolysis unit 155. In some embodiments, the caustic soda 156 is the caustic soda 156 produced by the downstream electrolysis unit 155. In other embodiments, the caustic soda 156 is purchased.

In embodiments where barium is removed from the influent water, the pH adjusted water from the pH adjustment tank 123 flows into a solids/liquid separator 125 as illustrated in FIG. 1B. In other embodiments, barium is not removed during treatment system 10. A flocculant 113 is added to the pH adjusted water in the solids/liquid separator 125. In some embodiments, the solids/liquid separator 125 is a gravity clarifier or an air floatation clarifier. In some embodiments, when hydrogen peroxide is utilized, the solids/liquid separator 132 is a dissolved air floatation clarifier.

In some embodiments, the pH adjusted water may be sent directly to a high volume dewatering process such as a centrifuge. In further embodiments, the water after passing though the solids/liquid separator 132 may also pass through a filtration device, such as a multimedia filter or a membrane filter for further solids/liquid separation. The solids/liquid separator 125 removes precipitated barium out of the water as barium sulfates and in some embodiments removes precipitated strontium out of the water as strontium sulfates. Further, in some embodiments, the solids/liquid separator 125 further oxidizes some of the residual petroleum hydrocarbons and reduces total organic carbon (TOC).

The separated solids 126 may then be subjected to end processing as illustrated in FIG. 1D. For example, the separated solids 126, precipitated barium sulfate, are then dewatered. The separated solids 126 may be dewatered by utilizing a dewatering system 27. The separated solids 126 may be dewatered by utilizing any known methods or system for dewatering. These dewatered solids may be sent to a landfill 28 or further processed. For example, the solids 126 may be washed to remove residual sodium chloride. Further, the separated solids 126, precipitated barium and strontium sulfate may be dried in a dryer 32. The dried barium and/or strontium sulfate are suitable for sale. Accordingly, the dried barium and/or strontium sulfate may be stored for sale 30. For example, the dried barium may be sold to E&P companies for use in drilling muds.

The clarified produced/flowback water from the solids/liquid separator 125 or the water from the pH adjustment tank 123 flows into a heat exchanger 26. The water may be heated to about 90-120 degrees Fahrenheit to improve removal of calcium and magnesium in the removal clarifier. In some embodiments, water is heated by using a plate and frame or shell in tube heat exchanger 26 with the source of heat being the condensate or the high quality distillate 154 generated by the downstream evaporation system 153 located downstream of these components. In some embodiments, the temperature may be increased beyond 120 degrees to further enhance the reaction. In other embodiments, the heat for heat changer 26 is from a source separate from system 10. In some embodiments, the heat exchanger 119 and heat exchanger 26 are similar.

The heated water from the heat exchanger 26 is flowed into another pH adjustment tank 127 to initiate a softening process. While the embodiments below are an example of a precipitative softening process, other methods of precipitative softening may be implemented by those skilled in the art. In the pH adjustment tank 127, the pH is adjusted to about 10.5-12.0. In some embodiments, sodium hydroxides is the reagent 128 utilized to adjust the pH of the clarified produce/flowback water. In alternative embodiments, other reagents 128 or a combination thereof are utilized to adjust the pH, such as calcium oxide/hydroxide and potassium hydroxide. In further embodiments, magnesium sulfate may be added to tank 127 to assist in the removal of silica. In other embodiments, the reagent 128 is a caustic soda 156 generated by the electrolysis unit 155 during downstream processing. In some embodiments, the reagent 128 is purchased.

Once the pH adjustment is completed, the pH adjusted water from the pH adjustment tank 127 flows into another solids/liquid separator 129 as illustrated in FIG. 1B. Soda ash 130 or some form of carbonate or carbon dioxide gas is added to the solids/liquid separator 129 at or near a stoichiometric amount to precipitate the calcium, barium, strontium, and other contaminants, typically as their carbonate or hydroxide forms. Alternatively, soda ash 130 may be added in tank 127 prior to the addition of caustic 156 or other alkali 111. A coagulant 108 of aluminum 121 or iron is added to the solids/liquid separator 129 to promote particle growth. Further, excess amounts of aluminum 121 may be added to the solids/liquid separator 129 to aid in the removal of fluoride. For example, the water discharged from the solids/liquid separator 129 has an aluminum residual of greater than 60 mg/L. In other embodiments, a coagulant 108 of iron is added in addition to the aluminum to the solids/liquid separator 129 to promote particle growth.

After the addition of the coagulant 108, a flocculant 113 is added to the solids/liquid separator 129. In some embodiments, the solids/liquid separator 129 is any known gravity or air floatation separator. Alternatively, in some embodiments, the solids/liquid separator 129 dewaters the pH adjusted water and then further treats utilizing a filtration system, such as a multimedia and/or a membrane system pursuant to these technologies' ability to handle high concentration of solids. This solids/liquid separator 129 removes scale forming compounds, such as calcium, barium, and strontium as the carbonate, magnesium as the hydroxide, fluorine as calcium fluoride, and silica as a magnesium silicate species. In additional embodiments, the solids/liquid separator 129 removes total metals to levels below 100 ppb. In some embodiments, for every 1 mg/l of calcium in the water, 1.18 mg/l of sodium carbonate is added to assist with softening. In further embodiments, for every 1 mg/l of magnesium in the water, 3.29 mg/l of sodium hydroxide is added to assist with removal of magnesium.

As illustrated in FIG. 1F, the separated solids 133 from solids/liquid separator 129 are dewatered. Any known dewatering systems may be utilized. After dewatering, in some embodiments, the solids 133 are rinsed with water to remove excess sodium chloride. In some embodiments, the solids 133 are suitable for sale. These salable solids may be placed in storage 30 before sale. In some embodiments, the solids 133 are suitable for sale after drying the solid with a dryer 32. For example, the produced solids 133 may be utilized to manufacture quick lime.

In other embodiments, as illustrated in FIG. 1F, the solids 133 after dewatering are calcined in calciner 159 to generate calcium oxide (quicklime) 160. The calcium oxide (or quicklime) 160 may be sold for other uses, such as concrete manufacturing or the neutralization of acid mine drainage or acid gas neutralization in coal fired power plants. If the calciner 159 is utilized, the carbon dioxide gas given off in the calciner 159 may be captured. In some embodiments as illustrated in FIG. 1F, the captured gaseous carbon dioxide is utilized to make sodium carbonate 166 by combining the carbon dioxide gas with caustic soda 156 in a reaction tank 162. This combination causes the sodium carbonate to separate from the water as soda ash in the reaction tank 162. Next, clarifier 164 is utilized to remove the soda ash from the water. The soda ash is subject to a dewater via a suitable dewatering system 27, such as a centrifuge to form sodium carbonate 166. In some embodiments, the utilized caustic soda 156 is caustic soda 156 produced by the downstream electrolysis unit 155. In some embodiments, the sodium carbonate 166 is sent back to pH adjustment tank 127 for use in the softening process as alkalis 111.

The produced/flowback water from the solids/liquid separator 129 is then passed through a weak acid cation (WAC) ion exchange column 139 and a chelating ion exchange column 140. The WAC ion exchange column 139 and the chelating ion exchange column 140 remove calcium, barium, magnesium and strontium to ultra-low levels of less than 50 ppb. Any suitable ion exchange resin may be utilized in the WAC ion exchange column 139 and the chelating ion exchange resin.

The WAC resin has a very high capacity to absorb and exchange divalent ions and is regenerated with both hydrochloric acid 157 and caustic soda 156. The chelating resins are also regenerated with caustic 156 and HCl (hydrochloric acid) 157. In some embodiments the resins are a DOW MAC-3 WAC® and Amberlite IRC7470 as sold by the Dow Chemical Company headquartered at 2030 Dow Center, Midland, Mich. 48674. In some embodiments, the utilized hydrochloric acid 157 and caustic soda 156 are produced by the downstream electrolysis unit 155. In other embodiments the hydrochloric acid 157 and caustic soda 156 are purchased. In some embodiments, the waste produced from regeneration is sent back to the facility influent structure for reprocessing. In other embodiments, the waste produced from regeneration is sent to a batch treatment system for treatment or recycled back to the beginning of system 10.

The produced/flowback water from the WAC ion exchange column 139 and the chelating ion exchange column 140 is brine consisting of mainly sodium chloride. All other ions such as barium, calcium, magnesium, strontium and others have been replaced with sodium in the produced/flowback water from the upstream treatment components, which provide chemical softening followed by ion exchange. The brine from the WAC ion exchange column 139 and the chelating ion exchange column 140 has a resulting TDS that has increased slightly. The TDS is increased because divalent ions have been replaced with 2 monovalent sodium ions. This brine from the WAC ion exchange column 139 and the chelating ion exchange column 140 is sent to another pH adjustment tank 143. The pH of the water is adjusted to between 9.5 and 12.0 using caustic soda 156 or other suitable alkali. As discussed above the caustic soda 156 may be produced from the downstream electrolysis unit 155 or may be purchased.

Unexpectedly, the addition of extra aluminum 121 in the solids/liquid separator 129 caused the aluminum 121 to precipitate out or come out of solution during following downstream pH adjustments. The pH is adjusted from 11.5 to 6.5 because the downstream alumina vessel 150 and the evaporator 153 work better a lower pH. In order to prevent the precipitated aluminum 121 from interfering with and/or fouling downstream components an aluminum removal system was added.

Initially a gravity clarifier was tried to remove the aluminum 121 because aluminum 121 settles. However, the gravity clarifier was unsuccessful in removing the aluminum 121. Upon further investigation it was determined that residual carbonate from the softening step was converting to CO₂ when the pH was adjusted from 11.5 to 6.5. When the produced CO₂ tries to bubble out of the solution, the resulting CO₂ gets trapped in the precipitated aluminum 121 causing the aluminum 121 to float to the surface.

The aluminum 121 removal system includes a pH adjustment tank 134, a floc mix tank 137, and a clarifier 131. The produced/flowback water from the chelating ion exchange column 140 is sent to a pH adjustment tank 134. The pH adjustment tank 134 changes the pH from 11.5 to 6.5.

Next, the pH adjusted water from the pH adjustment tank 134 is sent to a floc mix tank 137 and treated with a flocculant 113. A flocculant 113 may be any suitable flocculant 113 for treating waste water, such as any polyacrylamide based flocculant suitable for use in water or wastewater treatment. In some embodiments, based upon the discovery above, the floc mix tank 137 is filled with sand.

The flocculated water from floc mix tank 137 is sent to a clarifier 131. The clarifier removes the precipitated aluminum 121 from the water from the floc mix tank 137. Based on the CO₂ trapping in the aluminum, if no sand is utilized in the floc mix tank 137, then the clarifier 131 is a dissolved air floatation clarifier for removing the aluminum 121. If sand is utilized in the floc mix tank 137, then the clarifier 131 is a gravity clarifier forming a ballasted system for removing the aluminum 121.

In some embodiments, with the aluminum removed, the produced/flowback water from aluminum clarifier 131 is further treated to remove lithium. In some embodiments, a precipitant or coagulant 108 is added to the produced/flowback water from aluminum clarifier 131 to affect treatment in a reaction tank 142. Next, water with precipitated lithium and aluminum is then sent to a solids/liquid separator 135. In some embodiments, the precipitated lithium is removed in the solids/liquid separator 135 by gravity clarification and in other embodiments by dissolved air floatation or membrane filtration. The separated lithium and aluminum may be subject to end processing as illustrated in FIG. 1E. For example, lithium may be extracted from the aluminum/lithium sludge 18 with an extraction system 190. After the lithium is extracted it is dewatered with a dewatering system 27, such as a centrifuge. The recovered lithium may be sold for various applications. For example, lithium is utilized in electronics manufacturing, in battery manufacturing, and in pharmaceuticals. Any suitable method for removing lithium may be utilized in the system 10. In some embodiments, the recovered lithium is placed in storage 30 before sale as illustrated in FIG. 1E.

The produced/flowback water from the solids/liquid separator 135 or from the solids/liquid separator 129 is sent to a pH adjustment tank 136 as illustrated in FIG. 1B. The pH of the produced/flowback water from the solids/liquid separator 135 or from the solids/liquid separator 129 is adjusted to an elevated state with an alkali 111. Any alkali could be used in the pH adjustment tank 136 including caustic soda 156 produced in the downstream electrolysis system. The pH is adjusted to a pH of 10.5 or higher to aid in the removal of ammonia in the downstream membrane system 16 and tower 145. In some embodiments, the downstream membrane system 16 and tower 145 are performed directly after the solids/liquid separator 129 because the pH is of the effluent water from separator 129 is already at 11.5 eliminating the need for pH adjustment tank 136.

While an ammonia stripping tower may be utilized solely to remove a desired amount of ammonia from produced/flowback water, unexpectedly, the size of the ammonia stripping tower needed to effectively remove ammonia from produced/flowback water is extremely large. This large stripping tower requires a significant amount of space and money.

Based on our knowledge, semipermeable membrane systems have never been utilized to remove ammonia from produced/flowback waters. System 10 was implemented with a plurality of membranes of a membrane system 16 designed to allow the transport of ammonium ions across the semipermeable membrane into a cross flowing solution containing 1.0 normal sulfuric acid. An ammonia removal of at least 80% was desired. Surprisingly, in some embodiments, the membranes remove greater than 90% of ammonia from the water. The use of high temperatures and a high pH increase the removal rates of this technology.

Accordingly, the pH adjusted water from the pH adjustment tank 136 of system 10 is passed through one or more membranes of membrane system 16. As discussed above, the membrane system allows the transport of ammonium ions across the semipermeable membrane into a cross flowing solution containing 1.0 normal sulfuric acid. The ammonia in the pH adjusted water reacts with the sulfuric acid 141 to form ammonium sulfate. The ammonium sulfate is concentrated to up to 40% by weight by continuing to recycle the solution past the ammonia contacting membranes. This concentrated ammonium sulfate solution 170 can then be marketed and/or sold as a fertilizer for agricultural purposes. In some embodiments, the semipermeable membranes are Liqui-Cel® membranes as sold by Membrana located at 13800 South Lakes drive, Charlotte, N.C. 28273. As discussed above, in some embodiments, the membranes of membrane system 16 remove greater than 90% of ammonia from the water. For example, produced water containing 100 mg/l of ammonia elevated to a pH of 11.25 and heated to a temperature of 104 degrees Fahrenheit passed through a Liqui-Cel® membrane had an effluent ammonia concentration of 9 mg/l.

Next, if additional ammonia removal is desired, the water from the membrane system 16 is passed through a counter flow ammonia stripping tower 145. For example, the ammonia stripping tower 145 may be utilized if the remaining ammonia concentration is greater than 2 mg/l. The ammonia, which is the predominant nitrogen species in produced water, is removed by contacting a thin film of alkaline water to a high volume of air 146 in the stripping tower 145. The ratio of air to water is variable from 30 cfm to 1 lb of water up to 70 cfm per pound of water and is based upon the ammonia starting concentration and physics of the stripping tower. The air stream 146, containing ammonia is sent to a thermal oxidizer for conversion to nitrogen and discharge into the atmosphere. After both ammonia removal operations (membrane system 16 and tower 145) the water contains less than 1 mg/l ammonia. Alternatively, other suitable ammonia removal systems for system 10 as known by those skilled in the art may be utilized as long as these systems reduce the ammonia levels in the water to less than 1 mg/l of ammonia, such as steam stripping systems 34.

The purified brine/produced/flowback water containing low levels of nitrogen from the ammonia stripping tower 145 is transferred to an additional pH adjustment tank 147. In some embodiments, hydrochloric acid is added to purified brine/produced/flowback water in the pH adjustment tank 147 reduce the pH to a more neutral or slightly alkaline condition. As discussed above, the hydrochloric acid 157 may be acid produced by the downstream electrolysis unit 155 or purchased. The pH adjustment tank 147 adjusts the purified brine/produced/flowback water to a pH range of 8-10.5.

In some embodiments, the activated carbon columns 149 receive the pH adjusted water from pH adjustment tank 147 instead of being located after organics removal system as disclosed above.

The purified brine from the carbon columns 149 or the pH adjusted water from pH adjustment tank 147 passes through a polishing tank 150. The polishing tank 150 removes fluoride using activated alumina. The purified brine from the carbon columns 149 or the pH adjusted water from pH adjustment tank 147 flows through a pressure vessel containing activated alumina in the polishing tank 150. In some embodiments, the fluoride is removed to low levels to meet brine quality specifications, such as the specification shown in Example 1, Example 2, and Example 3 below. The activated alumina can be regenerated with acid 141, such as hydrochloric acid 157 and caustic soda 156. Again, the utilized hydrochloric acid 176 may be produced by the downstream electrolysis unit 155 or may be purchased. The regeneration waste may be sent back to the influent of system 10 for reprocessing or may be batch treated.

Next the polished water from the polishing tank 150 is flowed through a micro or ultrafiltration system 138. In alternative embodiments, the filter system 138 is a ceramic or polymeric system. In other embodiments, the filter 138 is a media filter. The filter 138 is selected to be suitable for the corrosion rate of concentrated sodium chloride solutions. The filter 138 removes colloidal solids, which could be any metalloid species.

Next, the filtered water from the filter 138 is passed through a second organics removal system. The second organic removal system is designed to remove organic acids and/or alcohols from the filtered water. Unexpectedly, the influent water contained a high amount of organic acid and alcohols that were not removed by the first organics removal system or any following downstream component. The second organics removal system produces water with a TOC goal of 10 mg/l or less.

TOC is a difficult and often nameless or faceless measurement. Two equivalent TOC values could be made up of very different organic components. In some embodiments, the second organics removal system provides for a TOC reduction of about 86.6%. The bulk of the remaining TOC left in the water by the time the water reaches the second organics removal system is made up of organic acids and alcohols. Organic acids and alcohols are often difficult to remove. In some embodiments, the influent water contains alcohols and organic acids at ppm levels. For example, the Optipore resin discussed above does not remove any organic acids or alcohols by reducing TOC even though the Optipore resin operates at above 99% efficiency in the removal of BTEX.

The second organics removal system includes a liquid to liquid extraction system 19, a steam stripping system 34, a crystallization system 20, and/or a photochemical oxidation system 22. While all of these systems are illustrated in FIG. 1C each may be utilized alone or in any combination with one or more of the other systems. Further, while FIG. 1C illustrates a specific order of the liquid to liquid extraction system 19, steam stripping system 34, the crystallization system 20, and/or the photochemical oxidation system 22 they may utilized in any order desired.

The liquid-liquid extraction system 19 creates a phase transfer from brine to solvent. The liquid-liquid extraction utilizes a unique organic solvent to remove the organic acids and alcohols. In some embodiments, the liquid-liquid extraction system 19 and organic solvent is the liquid-liquid extraction system 19 and organic solvent sold by Koch Modular Process Systems, LLC located at 45 Eisenhower Drive, Suite 350, Paramus, N.J. 07652. In some embodiments, the liquid-liquid extraction equipment of SCHEIBEL® Columns, KARR® Columns, rotating disc contactor (RDC) columns, pulsed, packed (SMVP) and/or a sieve tray are utilized as sold by Koch Modular Process Systems, LLC located at 45 Eisenhower Drive, Suite 350, Paramus, N.J. 07652.

The steam stripping system 34 includes a steam stripper tower and condensate collection system. The steam stripping system 34 utilizes steam stripping to remove the alcohols. Steam stripping, at a high temperature and pressure distills/evaporates the alcohol. The distilled/evaporated alcohol is then captured when the steam is condensed. Any conventional steam condensing system known to those skilled in the art is applicable. In some embodiments, the second organics removal system includes a liquid-liquid extraction system 19 typically followed by the steam stripping system 34. Steam stripping can also be utilized to remove ammonia. The condensed steam can then be distilled to separate and isolate the alcohols.

The crystallization system 20 includes an evaporator which concentrates the total dissolved solids beyond their solubility limit upon which crystallization occurs. The system would consist of a pH adjustment tank prior to the evaporator to reduce the pH to less than 3. The pH depression is necessary to fully protonate the organic acids. Typically, the organic acids are present initially as the sodium salt such as sodium acetate and have very high boiling points. Once the organic acids are protonated into the acid state, the boiling point decreases to within a range that is economically feasible to achieve. In some embodiments, the organic acids found in the influent water are acetic (boiling point (BP)=118 degrees Celsius), propionic (BP=141 degrees Celsius) and butyric (BP=163.5 degrees Celsius). Without pH depression these organic acids exist as a sodium salt, such as sodium acetate (BP=881.4 degrees Celsius). The crystallized solids, mainly salt are passed thru an oven elevating the temperature above the boiling point of the organic acids. Vapors from this over can be collected and the air purified by a wet scrubber. The overflow from the wet scrubber can be sent to a biological treatment system where the organic acids are converted to carbon dioxide and water. The salt will require reconstitution with water before proceeding to electrolysis.

The photochemical oxidation system 22 utilizes ultraviolet light in the presence of an oxidizer and catalyst to remove the organic acids and alcohols. Photochemical oxidation systems are known in the art. Any suitable photochemical oxidation system 22 may be utilized by the photochemical oxidation system 22 in system 10 for producing water with a TOC of 10 mg/L or less.

The purified brine from second organics removal system is evaporated in the evaporation tank 153 or evaporative brine concentrator 153 as illustrated in FIG. 1C. The evaporator tank 153 further concentrates the TDS in the purified brine to be in a range suited for the electrolysis process, typically about 290,000-310,000 mg/l TDS as sodium chloride. The purified brine from the activated alumina tank 150 supplies the evaporation tank 153 with purified brine reducing both the operational and the technical risk of evaporation technology compared to evaporating produced/flowback water and/or brine that is not as purified as the purified brine of system 10. In some embodiments, the evaporative brine concentrator 153 is a mechanical vapor recompression, a multiple effect with falling film evaporator, or a rising film evaporator. Any suitable evaporative brine concentrator 153 as known to those skilled in the art may be utilized in system 10. In embodiments, the steam in the evaporator tank 153 is condensed through cooling producing high quality distillate 154. The high quality distillate may be used as make-up water for chemical dilution throughout system 10. For example, high quality distillate may be sent to cooling towers, used as boiler feed, or polished and discharged to a publicly owned treatment works (POTW) or a NPDES permit. In other embodiments, some of the high quality distillate may be used to preheat water or regenerate the resin bed 117. In other embodiments, the high purity water is sold.

The concentrated purified brine from the evaporative brine concentrator 153 containing about 290,000 to 310,000 mg/l of sodium chloride enters the electrolysis unit 155 as illustrated in FIG. 1D. The electrolysis unit 155 converts the concentrated purified brine into sodium hydroxide 156, hydrogen 174, and chlorine gas 170 in a membrane cell. In some embodiments, the chlorine gas 170 is combined with the hydrogen 174 in a graphite furnace or chloride burner 172 to convert the two gases into hydrochloric acid 176 as illustrated in FIG. 1D. Additional hydrogen 174 may be added to balance the reaction. In other embodiments, the chlorine gas 170 is exposed to any type of steel, such as virgin grade steel or waste steel and dissolved water in reaction tank 178 as illustrated in FIG. 1D. The HCL dissolves the iron and the HOCI converts ferrous iron to ferric iron to form ferric chloride or iron chloride 182. Once the concentration of ferric chloride reaches an elevated concentration, the ferric will act as an etchant dissolving the iron itself and will become a self-propagating species. Chlorine will still be required to oxidize ferrous chloride to ferric chloride as ferrous chloride does not act as an etchant. In some embodiments, this reaction takes place at an elevated temperature of 125 to 160 degrees Fahrenheit. Alternatively, the sodium hypochlorite 158 can be manufactured by the electrolysis unit 155 instead of hydrochloric acid 157. Any known electrolysis units 155 suitable for purified brine may be utilized in system 10.

The sodium hydroxide 156, hydrochloric acid 176, and/or sodium hypochlorite 158 produced by the electrolysis unit 155 are all high purity products due to the use of high purity brine.

The market for high purity products, such as sodium hydroxide 156, hydrogen 174, sodium hypochlorite 158, and hydrochloric acid 157 is good. For example, in the U.S. approximately 12,131,000 dry tons of sodium hydroxide 156 is utilized annually with a market value of about $400 to $1200 per dry ton. Sodium hydroxide 156 is used in many industries including water treatment, wastewater treatment, metal finishing, pulp & paper as well as textile manufacturing. In an additional example, in the U.S. approximately 5,000,000 dry tons of hydrochloric acid 157 is utilized annually with a market value of about $200 to $400 per dry ton. Over 25% of the hydrochloric acid 157 usage in the U.S. is for well acidizing during hydraulic fracking. In addition, hydrochloric acid 157 is also used in the water treatment and wastewater treatment industries.

The system 10 illustrated in FIGS. 1A-1G show the treatment of influent water, which is contaminated produced water, to obtain a purified brine suitable for electrolysis, to produce barium sulfate, calcium carbonate, petroleum hydrocarbons 105, and/or lithium. The purified brine is utilized in electrolysis to manufacture caustic soda 156 and hydrochloric acid 157, as well as those compounds listed above, at purities that allow these materials to be sold to consumers for various applications. Further, the system 10 illustrated in FIGS. 1A-1F show the recovery of products added during the contaminated water treatment steps at purities that allows these recovered products to be utilized in the treatment of additional contaminated water or sold for other uses, such as carbon dioxide, calcium oxide, chlorine, magnesium oxide, lithium, barium sulfate, hydrogen 174 gas, chlorine gas 170, iron chloride 182, and calcium carbonate.

Further, in system 10 in some embodiments, a demulsifier may be added to the water prior to the oil and water separator 104. In some embodiments, the organics removal system including tank 147, activated carbon columns 149 and polishing tank 150 are not utilized after the brine purification system and are instead utilized between the one or more equalization tank 106 of the oil removal and recovery system and the coagulation tank 107 of the TSS and Iron removal system. While the ammonia stripping tower 145 is located in a specific position in the brine purification system, in some embodiments, the ammonia removal system is located anywhere after the pH adjustment tank 136. In another alternative embodiment, the WAC ion exchange column 139 and the chelating ion exchange column 140 are located after the evaporative brine concentrator 153 before the electrolysis unit 155 instead of being located after the brine purification system. In some embodiments where caustic 156 is utilized, lime may be utilized instead. In another alternative embodiment, the solids/liquid separators may be a centrifuge, belt press, or filter press. In another alternative embodiment, the soda softening system and the aluminum and lithium removal system illustrated in FIG. 1B are switched in order. In another embodiment, the solids/liquid separator 129 may remove silica in addition to the calcium carbonate and magnesium hydroxide.

Systems located within the system 10, such as “the soda softening system” and “the aluminum removal system,” include the main feature component (e.g., solids/liquid separator 129 or aluminum clarifier 131) along with any mix tanks, pH adjustment tanks, and/or heat exchangers that are necessary and/or included to improve the purpose of the main feature component.

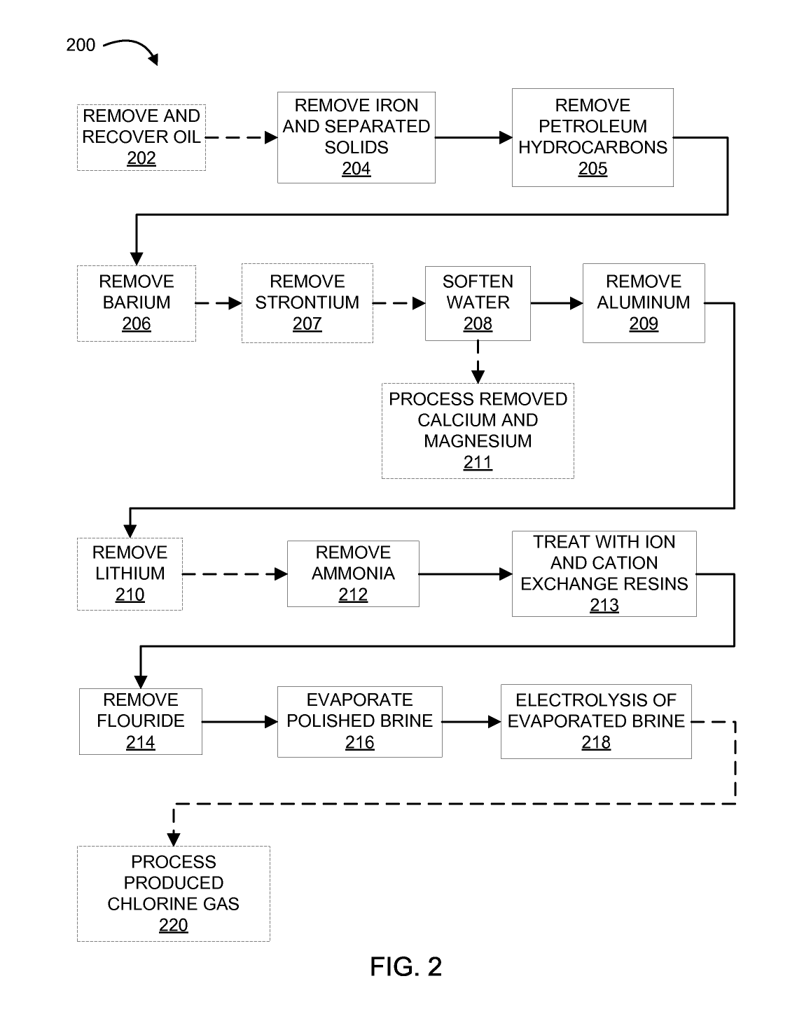

FIG. 2 illustrates an embodiment of a method 200 for producing sodium hydroxide, hydrochloric acid, and/or sodium hypochlorite from contaminated water. As illustrated, in some embodiments, method 200 includes a removing and recovering oil operation 202. During operation 202, oil is removed and recovered from contaminated water to produce a reduced oil effluent. For example, one system for removing and recovering oil from contaminated water is to adjust the pH of the contaminated water to about 4-5 and then recover separated oil with a liquid oil separator. For an example, see FIG. 1A. The recovered oil is suitable for sale.

Method 200 includes an iron and solids removal operation 204. During operation 204 iron and separated solids are removed from the reduced oil effluent or influent water to produce an iron reduced effluent. In some embodiments, the solids and iron are removed by adding an oxidizer to oxidize ferrous iron to ferric iron and sulfides to sulfates. Next, a coagulant may be added to the oxidized water. The pH of the coagulated water is adjusted to a pH of 6.5-7.5. Next, flocculant is added to the pH adjusted water. After the addition of flocculant the iron and separated solids in the water are removed. For an example, see FIG. 1A. Further, in some embodiments, the flocculated solids from the liquid/solids separation system are filtered and dewatered. The separated solids may mainly include iron hydroxides and iron carbonates.

Next method 200 includes a first organics removal operation 205. During the operation 205, petroleum hydrocarbons are removed from the iron reduced effluent or reduced oil effluent to produce an organics reduced effluent. Petroleum hydrocarbons include gasoline, diesel, and oil. In some embodiments, an organo clay system and activated carbon filters are utilized to reduce the petroleum hydrocarbons. In other embodiments, an ion exchange resin, such as an Optipore L493® resin and activated carbon filters are utilized to remove petroleum hydrocarbons. Operation 205 reduces TOC to 140 mg/l as well as removes over 99% of BTEX found in the iron reduced effluent.

In some embodiments, method 200 includes a barium removal operation 206. During operation 206, barium is removed from the reduced iron effluent to produce a reduced barium effluent. For example, during operation 206, the reduced barium effluent may be heated before being mixed with sulfuric acid and/or sodium sulfate at a stoichiometric amount to precipitate barium and strontium out as sulfates. This reaction is conducted under acidic conditions, optionally, in the presence of a high concentration of an oxidizer. The oxidizer may be, but is not limited to, hydrogen peroxide, sodium or potassium permanganates, sodium or potassium persulfates, ozone or other advanced oxidation technologies known to those skilled in the art. In some embodiments, the contact time in this step is less than 30 minutes. Next, for example, during operation 206, the pH of the reduced barium water is adjusted to raise the pH to a neutral level. This pH adjustment is beneficial for following solids/liquid separation steps, such as flocculation. Next, for instance, during operation 206, a flocculant is added to the pH adjusted water to help remove precipitated barium and strontium out of the water as sulfates. Optional oxidizer addition further oxidizes some of the residual petroleum hydrocarbons to reduce the total organic carbon (TOC). In some embodiments, the water is additionally filtered. In some embodiments, during operation 206 the separated, precipitated barium and/or strontium sulfate are dewatered and dried. The dried barium and/or strontium sulfate are suitable for sale.

In some embodiments, method 200 includes a strontium removal operation 207. During the strontium removal operation, strontium is removed from effluent to produce the strontium reduced effluent. The strontium removal operation 207 is performed after the petroleum hydrocarbon removal operation 205 and before the softening operation 208. In some embodiments, the strontium removal operation 207 utilizes a strontium specific ion exchange resin. For example, iron oxide coated sand may be utilized to reduce the levels of strontium in the water. The strontium removal operation 207 creates an effluent with less than 0.1% strontium. In some embodiments, water flowing into the strontium removal operation 207 has a concentration of strontium of about 5%. However, this level of strontium is exemplary only and will vary based on the produced/flowback water processed by method 200.

Further, method 200 includes a softening water operation 208. During operation 208, one or more of calcium and magnesium and other remaining contaminants are removed from the reduced barium effluent, strontium reduced effluent, or iron reduced effluent to produce a softened effluent or softened water. For example, the pH of the softened effluent is adjusted to about 10.5-12.0 by adding caustic or other alkali such as lime, or a combination thereof. The removal of fluorine as CaF₂ may be enhanced through the addition of lime and aluminum. In some embodiments, magnesium sulfate is added to assist in the removal of silica. Once the pH adjustment is completed, soda ash or some form of carbonate or carbon dioxide gas is added to the pH adjusted water to precipitate out a stoichiometric amount of calcium as calcium carbonate and other contaminants as a carbonate or hydroxide. Alternatively, the soda ash may be added to the pH adjusted water prior to the addition of caustic.

Next, for example, a coagulant, consisting of any inorganic coagulant of iron or aluminum may be added to the pH adjusted water to promote particle growth. After the addition of the coagulant 108, a flocculant 113 is added to the water. After these additions, scale forming compounds are removed from the water, such as calcium as the carbonate, magnesium as the hydroxide, and silica as a magnesium silicate species. In additional embodiments, operation 208 removes total metals to levels below 100 ppb. In some embodiments, the water is further filtered.

In some embodiments, method 200 also includes a calcium processing operation 211. During the calcium processing operation, the removed calcium and magnesium is processed to produce at least one of calcium oxide and sodium carbonate. The removed solids, mainly including calcium carbon and magnesium hydroxide are dewatered and then rinsed with water to remove excess sodium chloride. In some embodiments, the solids produced from operation 208 are suitable for sale. In other embodiments, the dewatered solids from operation 208 are calcined to generate calcium oxide (quicklime). Additionally, the calcium oxide (or quicklime) may be sold for other uses. In additional embodiments, the calcined dewater solids are further processed with caustic soda and further dewatering to produce sodium carbonate during operation 211.

Method 200 includes an aluminum removal operation 209. During the aluminum removal operation 209, aluminum is removed from the softened effluent to produce a clarified effluent. Unexpectedly, the addition of extra aluminum during the soda softening operation 208 caused aluminum to precipitate out or come out of solution during following downstream pH adjustments. Operation 209 removes the precipitated aluminum to prevent fouling or interference with downstream component by the precipitated aluminum. During the aluminum removal operation 209, the pH is first adjusted to 6.5. After the pH adjustment, flocculant is added to the pH adjusted water. In some embodiments, the flocculent and sand are added in a tank. Next, during operation 209, precipitated aluminum is removed from the flocculated water. Based on CO₂ trapping in the aluminum, if no sand is utilized during the addition of flocculant, then the clarifier is a dissolved air floatation clarifier for removing the aluminum. If sand is utilized during the addition flocculant, then a gravity clarifier forming a ballasted system is utilized to remove the aluminum. In some embodiments, the ballasted clarifier is a BioMag™ or CoMag™ as sold by Siemens located at 4800 North Point Parkway, Suite 250, Alpharetta, Ga. 30022 USA.

In further embodiments, method 200 includes a removing aluminum/lithium operation 210. During operation 210, aluminum and lithium are removed from the clarified effluent to form a lithium reduced effluent. For example a precipitant is added to the softened effluent to precipitate out lithium and aluminum. Next, for example, the precipitated lithium and/or aluminum are separated out from the water. The recovered lithium may be sold for various applications after end processing as illustrated in FIG. 1F, such as extraction and dewatering.

Additionally, method 200 includes an ammonia removal operation 212. During operation 212, ammonia is removed from the clarified effluent or from the lithium reduced effluent to produce a purified brine. For example, during operation 212, the pH of the brine is adjusted to an elevated state with an alkali prior to passing through membrane system. Any alkali could be used in the pH adjustment tank. In some embodiments, the alkali is calcium or magnesium hydroxide. In alternative embodiments, the alkali is caustic soda which avoids redissolving hardness ions. In some embodiments, the membrane system is a system that allows the transport of ammonium ions across a semipermeable membrane into a cross flowing solution containing 1.0 normal sulfuric acid. The ammonia in the pH adjusted water reacts with the sulfuric acid to form ammonium sulfate. The ammonium sulfate is concentrated to up to 40% by weight by continuing to recycle the solution past the ammonia contacting membranes. This concentrated ammonium sulfate solution may be marketed and/or sold as a fertilizer for agricultural purposes. In some embodiments, the semipermeable membranes are Liqui-Cel® membranes as sold by Membrana located at 13800 South Lakes drive, Charlotte, N.C. 28273. The membrane system removes greater than 90% of ammonia from the water. For example, produced water containing 100 mg/l of ammonia elevated to a pH of 11.25 and heated to a temperature of 104 degrees Fahrenheit passed through a Liqui-Cel® membrane had an effluent ammonia concentration of 9 mg/l. In some embodiments, the sulfuric acid stream containing insoluble ammonium sulfate can be further separated during operation 212 to recover the ammonium sulfate. The ammonium sulfate may be sold for other applications. For example, the ammonium sulfate may be utilized as fertilizer.

Next, during operation 212, if additional ammonia removal is desired, the water from the membrane system is passed through a counter flow ammonia stripping tower or other suitable ammonia removal system if the ammonia concentration is greater than 2 mg/l. The ammonia, which is the predominant nitrogen species in produced water, may be removed, for example, by contacting a thin film of alkaline water to a high volume of air. The ratio of air to water is variable from 30 cfm to 1 lb of water up to 70 cfm per pound of water and is based upon the ammonia starting concentration and physics of the stripping tower. The air stream, containing ammonia is sent to a thermal oxidizer for conversion to nitrogen and discharged into the atmosphere.

After both ammonia removal operations (membrane system and tower), the water contains less than 1 mg/l. Alternatively, other suitable ammonia removal systems for method 200 as known by those skilled in the art may be utilized as long as these systems reduce the ammonia levels in the water to less than 1 mg/l.

Next, method 200 includes a treat operation 213. During treat operation 213 the purified brine is treated with weak acid cation and ion exchange resins to form a scale ion free brine. In some embodiments, the purified brine is passed through a weak acid cation (WAC) ion exchange column and a chelating ion exchange column to remove remaining calcium, barium, magnesium and/or strontium to ultra-low levels of less than 50 ppb. Any suitable ion exchange resin may be utilized in the WAC ion exchange column and the chelating ion exchange resin.

As illustrated, method 200 includes a remove fluoride operation 214. During the remove fluoride operation 214, fluoride is removed from scale ion free brine to produce a polished brine. For example, during operation 214 the scale ion free brine is pumped into a pressure vessel containing activated alumina to remove any remaining fluoride after softening. In some embodiments, the fluoride is removed to low levels to meet brine quality specifications, such as the specification shown in Example 1, Example 2 and/or Example 3 below. The activated alumina can be regenerated with hydrochloric acid and caustic soda. In some embodiment, operation 214 also includes pumping the polished brine into one or more activated carbon columns for final polishing and removal of trace contaminants prior to the removal of fluoride, such as iodine and some metals. Some organic substances will be removed in this step to continue to reduce the TOC.

Further, method 200 includes an evaporating operation 216. During operation 216, the polished brine is evaporated to produce a concentrated brine. For example, during operation 216, the polished brine is evaporated in an evaporative brine concentrator. The evaporation concentrates the TDS in the polished brine to be in a range of about 290,000-310,000 mg/l TDS as sodium chloride. In some embodiments, the evaporative brine concentrator is a mechanical vapor recompression, a multiple effect with falling film evaporator, or a rising film evaporator. Any suitable evaporative brine concentrator as known to those skilled in the art may be utilized in method 200. The steam from the evaporation may be condensed through cooling producing high quality distillate. For example, high quality distillate may be sent to cooling towers, used as boiler feed, or polished and discharged to a publicly owned treatment works (POTW) or a NPDES permit. In other embodiments, some of the high quality distillate may be used to preheat water or regenerate resin. The high quality distillate may also be sold.

Method 200 also includes an electrolysis operation 218. During operation 218, the concentrated brine is treated by electrolysis to produce sodium hydroxide, hydrochloric acid, and/or sodium hypochlorite. In some embodiments, during operation 218, the concentrated brine is treated by electrolysis to produce chlorine gas and/or hydrogen. For example, during operation 218, the concentrated brine containing approximately 290,000 to 310,000 mg/l of sodium chloride enters an electrolysis unit to convert the concentrated brine into sodium hydroxide, hydrogen, and chlorine gas in a membrane cell. The chlorine gas is combined with the hydrogen in a graphite furnace to convert them to hydrochloric acid. Additional hydrogen may be added to balance the reaction. Alternatively, sodium hypochlorite can be manufactured by the electrolysis unit instead of hydrochloric acid. Any know electrolysis units suitable for purifying brine may be utilized in method 200.

In additional embodiments, method 200 includes a chlorine gas process operation 220. During the chlorine gas process operation, chlorine gas produced by operation 218 is processed to produce iron chloride. The process includes mixing the chlorine gas with steel to form iron chloride. The iron chlorine may be suitable for storage and sale for other uses.

The sodium hydroxide, hydrochloric acid, chlorine gas, hydrogen gas, iron chloride, and/or sodium hypochlorite produced by method 200 are all high purity products due to the use of high purity brine. There is a good market for high purity products, such as sodium hydroxide, hydrogen, sodium hypochlorite, and hydrochloric acid.

### EXAMPLES

### Example 1

In one embodiment, the brine and analyte specification shown below in Table 1 are fed into the inlet of the electrolysis unit 155 as shown in FIG. 1C.

TABLE 1
Example brine and analyte specification for electrolyzer.

| Component | | | Unit |
|---|---|---|---|
| NaCl | approx. | 300-310 | gpl |
| NaOH | excess approx. | 0.2 | g/l |
| Na₂CO₃ | excess approx. | 0.4 | g/l |
| Br | max. | 50 | ppm |
| Co | max. | 10 | ppb |
| Ca + Mg | max. | 20 | ppb |
| Sr | max. | 60 | ppb |
| I | max. | 0.2 | ppm |
| Ba | max. | 0.5 | ppm |
| Na₂SO₄ | max. | 10 | gpl |
| NaClO₃ | max. | 10 | gpl |
| SiO₂ | max. | 5 | ppm |
| Al | max. | 0.1 | ppm |
| Ni | max. | 10 | ppb |
| Mn | max. | 150 | ppb |
| Hg | max. | 0.1 | ppm |
| Pb | max. | 50 | ppb |
| Nitrogen Compounds (as N) | max. | 1 | ppm |
| Fe | max. | 50 | ppb |
| F | max. | 1 | ppm |
| H₂O₂ | max. | 0.2 | ppm |
| Suspended Solids | solids max. | 0.5 | ppm |
| Total Heavy Metal (as Pb) | max. | 0.2 | Ppm* |
| TOC | max. | 7 | ppm |
| pH | | 8-10.5 | |
| Temperature | approx. | 65 | deg. C. |
| Pressure | approx. | 2 | bar g |
| Flow Rate | approx. | | m³/h |

*Total heavy metals include the total of: Pb, Co, Mn, Cr, Cd, Cu, Zn, Ti, Mo, and Li.

### Example 2

In another embodiment, the brine and analyte specification shown below in Table 2 are fed into the inlet of the electrolysis unit 155 as shown in FIG. 1C.

TABLE 2
Example brine and analyte specification for electrolyzer.

| | | Salt with Primary | Vacuum Salt w/o |
|---|---|---|---|
| Component | Unit | Treatment Max. | Primary Max |
| Fluoride | ppm (ug/g) | 3 | 3 |
| Acetate** | ppm | | |
| Formate** | ppm | | |
| Nitrite*** | ppm | | |
| Sulfate | ppm | | |
| Bromide | ppm | 150 | 150 |
| Nitrate*** | ppm | | |
| Phosphate | ppm | | |
| Iodide | ppm | 0.6 | 0.6 |
| Sulfur | ppm | 60 | 60 |
| Total Organic | ppm (ug/g) | 10 | 10 |
| Carbon | | | |
| Ag | ug/g | | |
| Al | uglg | 1.5 | 0.5 |
| As* | ug/g | | |
| Ba | uglg | 0.75 | 0.75 |
| Be | ug/g | | |
| Ca | ug/g | 0.3% | Ca + Mg < 30 |
| Cd* | ug/g | | |
| Co* | ug/g | 20 ppb | 20 ppb |
| Cr* | uglg | | |
| Cu* | ug/g | | |
| Fe | ug/g | 3 | 3 |
| Hg | ug/g | 0.3 | 0.3 |
| K | ug/g | | |
| Li | uglg | | |
| Mg | ug/g | 0.35% | Ca + Mg < 30 |
| Mn* | uglg | 450 ppb | 450 ppb |
| Mo* | ug/g | | |
| Na | uglg | | |
| Ni* | ug/g | 0.6 | 0.6 |
| P | ug/g | | |
| Pb* | uglg | 150 ppb | 150 ppb |
| Sb* | ug/g | | |
| Se | ug/g | | |
| Si | ug/g | 15 as SiO₂ | 15 as SiO₂ |
| Sn* | ug/g | | |
| Sr | uglg | 300 | 6 |
| Ti* | ug/g | | |
| TI | ug/g | | |
| V | ug/g | | |
| W | ug/g | | |
| Zn* | ug/g | | |
| Zr | ug/g | | |

*Total heavy metals include the total of: Pb, Co, Mn, Cr, Cd, Cu, Zn, Sn, Ti, Mo, Ni, As, and Sb. The limit is 0.6 ppm.
**Included in TOC
***Nitrogen compounds (as NH₄): max 3 ppm

### Example 3

In another embodiment, the brine and analyte specification shown below in Table 3 are fed into the inlet of the electrolysis unit 155 as shown in FIG. 1C.

TABLE 3
Example brine and analyte specification for electrolyzer.

| | | AKCC | CEC | | |
|---|---|---|---|---|---|
| | | (Asahi | (Chlorine | | |
| Component | Units | Kasel) | Engineers) | Ineos | Uhde |
| Feed Brine pH | — | 10.5-11.5 | ≈9 | <11.6* | 0-10.5 |
| NaOH Excess | g/L | — | — | — | <0.4 |
| Na2CO3 | g/L | — | — | — | <0.8 |
| Excess | | | | | |
| NaCl | g/L | 300-310 | 300-315 | >270 | 305 ± 5 |
| Na2SO4 | g/L | <7.4 | 08-April | <8* | 10-June |
| NaClO3 | g/L | — | <10 | <31.9 | <10 |
| Ca + Mg | ppm | ≦0.02 | <0.02 | <0.02 | <0.02 |
| | w/w | | | | |
| Mg | ppm | — | — | <0.01 | — |
| | w/w | | | | |
| Sr | ppm | ≦0.1 | <0.4 | <0.1 | <0.4 |
| | w/w | | | | |
| Ba | ppm | ≦0.1 | <0.5 | <0.1 | <0.1 |
| | w/w | | | | |
| Soluble SiO2 | ppm | ≦5 | <5 | <5 | <5 |
| | w/w | | | | |
| Total SiO2 | ppm | — | — | <15 | — |
| | w/w | | | | |
| Al | ppm | ≦0.1 | <0.1 | <0.1 | <0.1 |
| | w/w | | | | |
| Fe | ppm | ≦0.05 | <0.1 | <0.15 | <0.050 |
| | w/w | | | | |
| Hg | ppm | ≦0.1 | <0.1 | <0.50 | <0.1 |
| | w/w | | | | |
| Mn | ppm | — | <0.01 | <0.05 | <0.15 |
| | w/w | | | | |
| Ni | ppm | ≦0.01 | <0.01 | <0.01 | <0.01 |
| | w/w | | | | |
| Pb | ppm | — | — | <0.05 | <0.05 |
| | w/w | | | | |
| Co | ppm | — | — | — | <0.01 |
| | w/w | | | | |
| Total Heavy | ppm | — | <0.1 | — | <0.2 |
| Metals | w/w | | | | |
| (Except Hg) | | | | | |
| Iodine | ppm | ≦0.1 | <0.2 | <0.2 | <0.2 |
| | w/w | | | | |
| Fluorine | ppm | — | <0.5 | — | <1 |
| | w/w | | | | |
| Bromine | ppm | ≦30 | — | — | <50 |
| | w/w | | | | |
| Free Cl₂ | ppm | nil | — | Non | <0.1 |
| | w/w | | | Detectable | |
| SS | ppm | ≦0.5** | <1.0 | — | <0.5 |
| | w/w | | | | |
| TOC | ppm | ≦10 | <10 | — | <7 |
| | w/w | | | | |
| NH4 | ppm | — | — | — | <1 |
| | w/w | | | | |
| Temperature | deg. F. | ≈140 | 140-149 | >140 | 122-176 |
| Pressure | psig | ≧43 | ≈29 | — | — |

*@ 23 deg. C.
**mg/L
— Spec Not Stated

In this example, once the electrolysis is completed, the dechlorinated brine is recycled to a brine saturation and evaporation system. The flow rate of the dechlorinated brine is about 120 gpm at 100 short ton/day NaOH (dry basis) cell production. Example concentrations for the dechlorinated brine are illustrated below in Table. 4.

TABLE 4
Example concentrations for the dechlorinated brine.

| Component | Units | Value |
|---|---|---|
| Dechlorinated Brine | pH | 9 |
| NaCl | g/L | 200 ± 5 |
| Na₂SO₄ | g/L | 10 |
| NaClO₃ | g/L | 10 |
| Na₂SO₃ | ppm water | 20 |
| Temperature | Degrees Fahrenheit | ~176 |

### Example 4

In some embodiments, the influent water (or produced/flowback water) treated in the contaminated water treatment system, such as system 10 as shown in FIG. 1A includes contaminants at the ranges listed in TABLE 4 below:

TABLE 4
Produced/Flowback Influent Water Quality Ranges

| Parameter | Influent Concentration (mg/l) |
|---|---|
| Aluminum | .08-1.2 |
| Barium | .5-15,700 |
| Calcium | 29-34,000 |
| Cobalt | .03-.6 |
| Fluoride | 4-780 |
| Iron | 1-810 |
| Lead | .02-.5 |
| Manganese | .2-15 |
| Magnesium | 9-3190 |
| Nickel | .01-.14 |
| Nitrogen | 12-382 |
| Silicon dioxide | 9-100 |
| Strontium | .5-5841 |
| TOC (total organic | 69-1080 |
| carbon) | |
| Total Heavy Metals | >2 |
| TSS | 30-2000 |

### Example 5

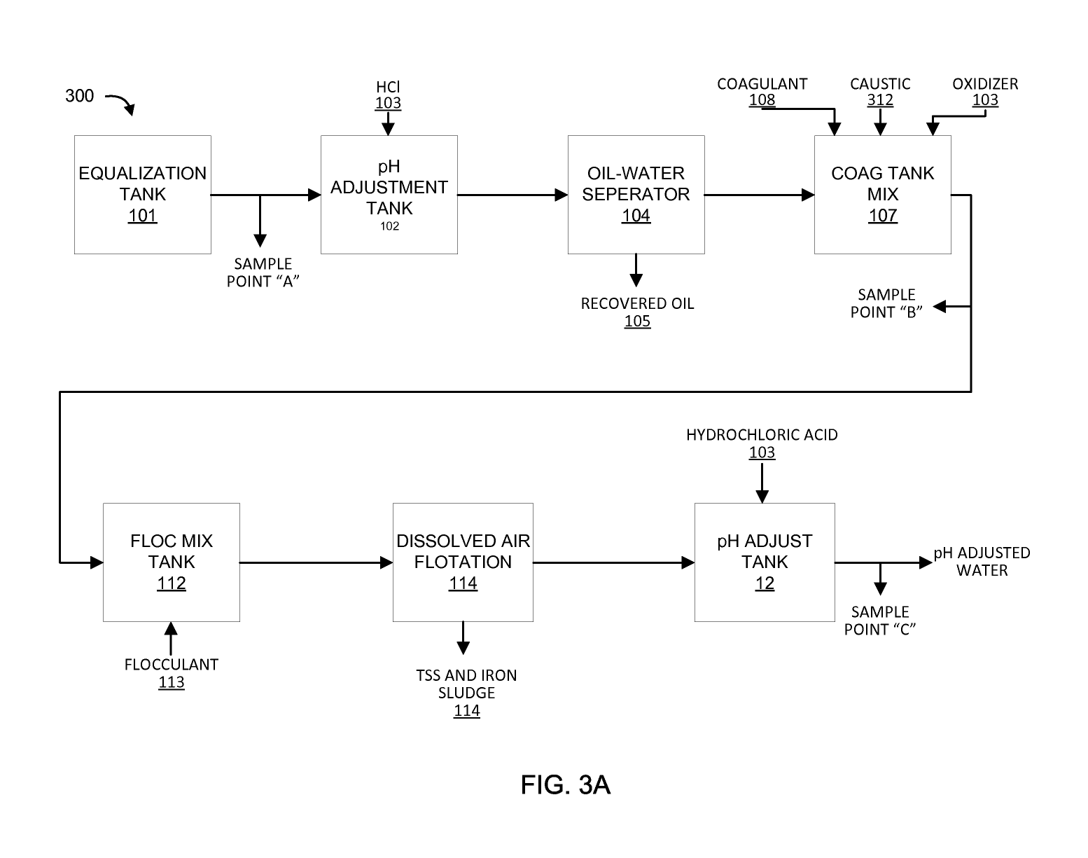

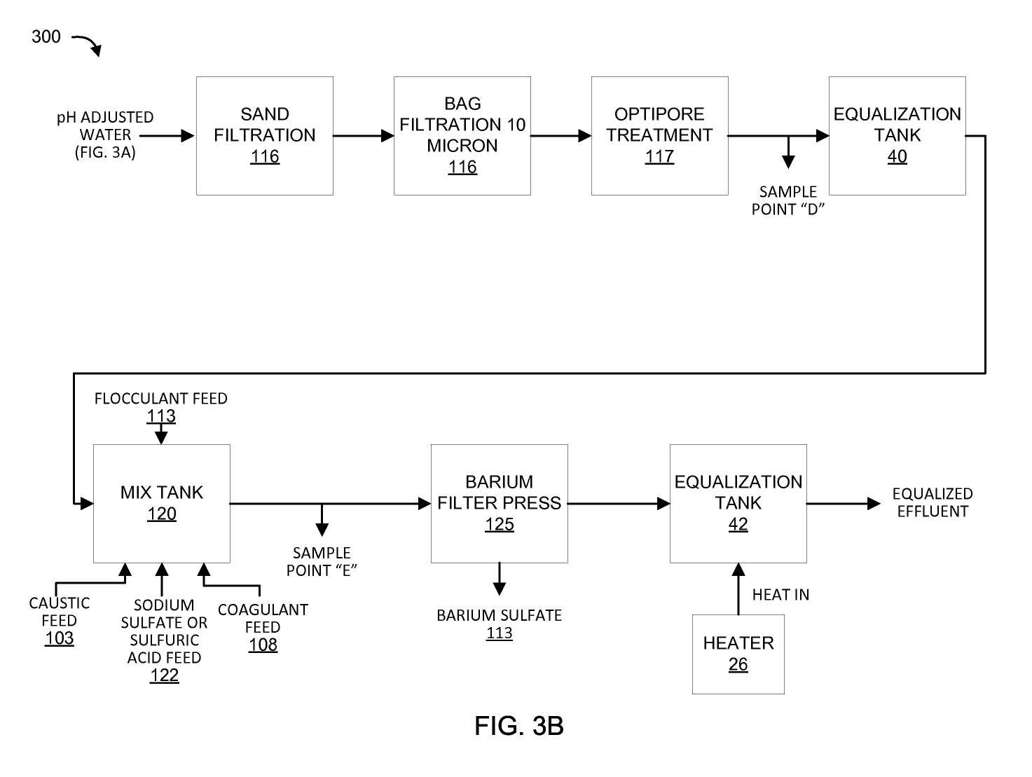

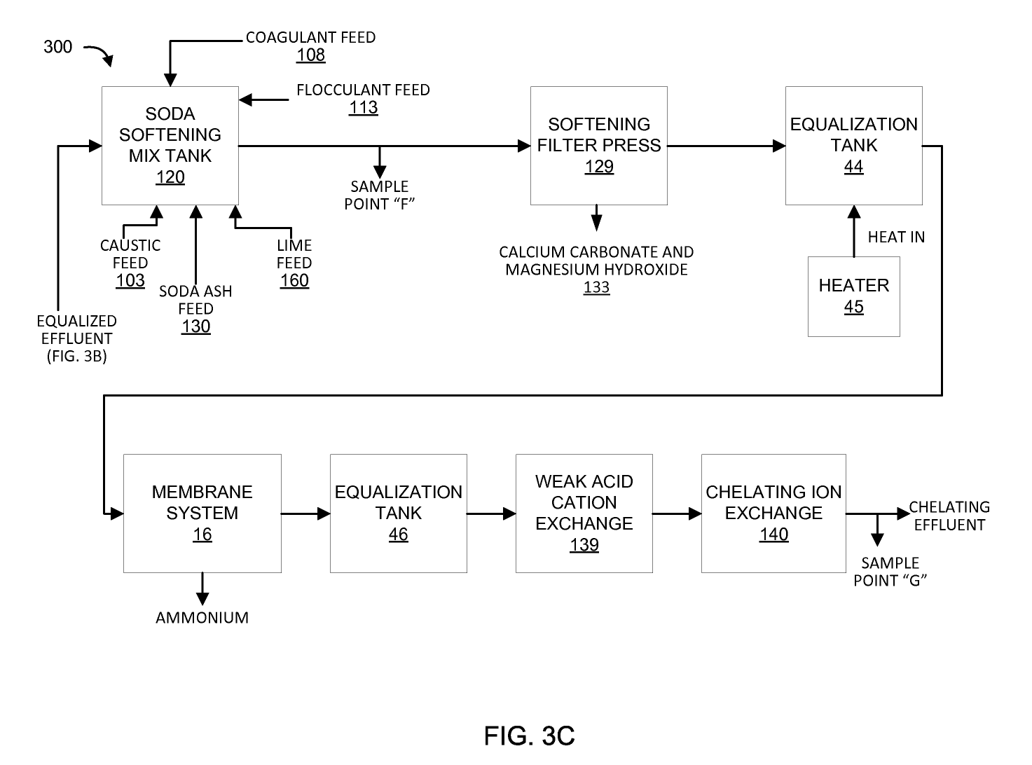

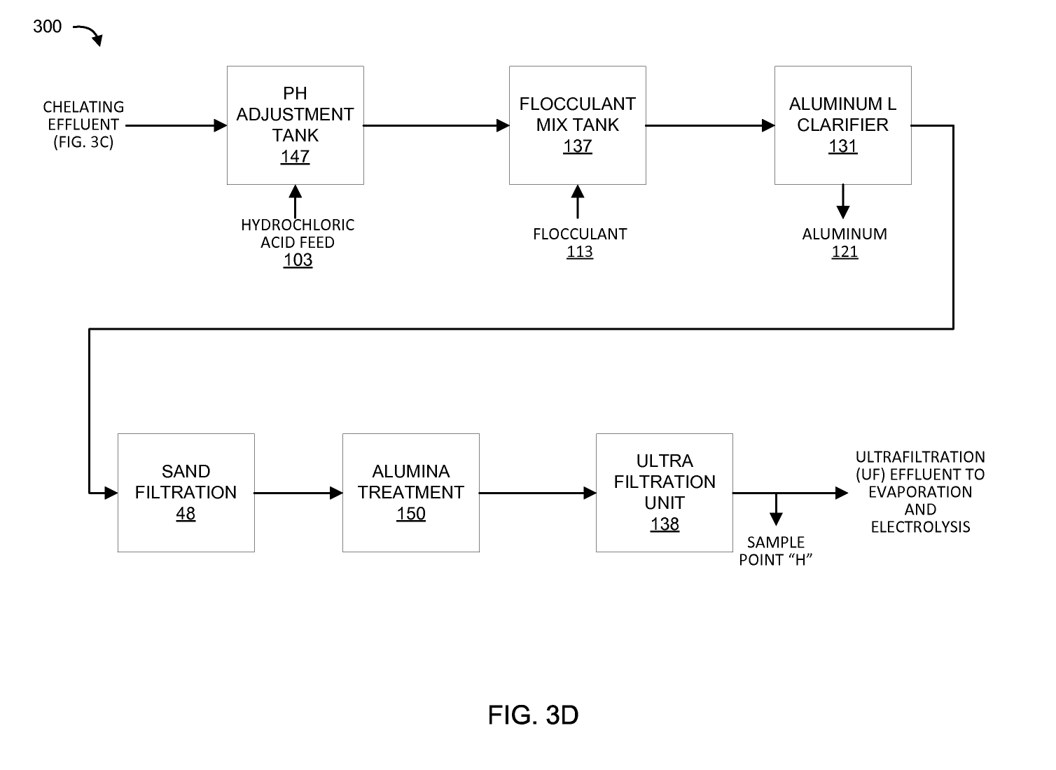

FIGS. 3A-3D illustrate an embodiment of a water treatment system 300 for treating contaminated water to produce a purified brine according to the principles of the present disclosure. FIGS. 3A-3D show a pilot system 300 that processed influent wastewater. Each of the components of FIGS. 3A-3D are fully described in further detail in the description of FIGS. 1A-1C above. However, due to the small scale and limitations of a pilot system, several mix tanks and/or pH adjust tanks were combined and/or combined with other components. Further, due to the small scale and batch processing of a pilot system, additional equalization tanks 40, 42, 44, and 46 were also utilized in system 300 which were not utilized in system 10 as illustrated in FIGS. 1A-1C and as discussed above. Additionally, FIGS. 3A-3D also utilize additional heaters 45 and filters 48 based on the small scale and design of the pilot system, which were not illustrated or discussed above in FIGS. 1A-1C.

The influent waste water that ran through the pilot system 300 illustrated in FIGS. 3A-3D was analyzed and the components of the influent water or raw water are shown in Table 5 below. Water at various stages of treatment within the pilot system 300 was analyzed. The results of this analysis are listed in Table 5 below. Each position of water analysis has been labeled with a letter as shown in Table 5 below. Each position of water analysis is shown in FIG. 5 via the letter label.

TABLE 5
Water analysis results at different positions during treatment for pilot system

| | | | | | Barium | | | |
|---|---|---|---|---|---|---|---|---|
| | Raw | DAF | DAF | Optipore | Clarifier | Softening | Chelate | UF |
| | Water | Inf. | Eff. | Eff. | Eff. | Effluent | Eff. | Eff. |
| | “A” | “B” | “C” | “D” | “E” | “F” | “G” | “H” |
| Element | (mg/l) | (mg/l) | (mg/l) | (mg/l) | (mg/l) | (mg/l) | (mg/l) | (mg/l) |
| Ag | ND | ND | ND | ND | ND | ND | ND | ND |
| Al | 3.29 | 0.98 | 1.47 | 1.3 | 0.88 | 3.04 | 3.04 | 0.67 |
| Ba | 6318 | 7012 | 6833 | 6974 | 0.37 | 0.04 | 0.04 | 0.06 |
| B | 9.39 | 9.12 | 8.85 | 9.17 | 8.84 | 3.52 | ND | 4.69 |
| Bi | ND | ND | ND | ND | ND | ND | ND | ND |
| Ca | 13519 | 14992 | 14592 | 14875 | 13407 | 0.72 | 0.07 | ND |
| Co | ND | ND | ND | ND | ND | ND | ND | ND |
| Cd | ND | ND | ND | ND | ND | ND | ND | ND |
| Cr | ND | ND | ND | ND | ND | ND | ND | ND |
| Cu | 0.01 | ND | ND | ND | ND | 0.01 | ND | ND |
| Fe | 25.54 | ND | ND | ND | ND | ND | ND | ND |
| Ga | ND | ND | ND | ND | ND | 0.09 | ND | ND |
| Hg | ND | ND | ND | ND | ND | ND | ND | ND |
| In | ND | ND | ND | ND | 0.19 | ND | ND | ND |
| K | 258.57 | 277.95 | 281.7 | 295.15 | 286.46 | 198.39 | 154.71 | 189.6 |
| Li | 101.61 | 113.93 | 114.53 | 120.24 | 124.87 | 65.78 | 15.21 | 57.77 |
| Mg | 1174 | 1393 | 1377 | 1393 | 1307 | 0.09 | ND | ND |
| Mn | 2.6 | 1.47 | 1.49 | 1.53 | 1.91 | ND | ND | ND |
| Mo | 0.01 | ND | 0.02 | ND | ND | ND | ND | ND |
| Na | 32482 | | | | 39330 | 62191 | 61978 | 60692 |
| Ni | ND | ND | ND | ND | 0.03 | ND | ND | ND |
| Pb | 0.32 | ND | ND | ND | ND | ND | ND | ND |
| Se | ND | ND | ND | ND | ND | ND | ND | ND |
| Si | 3.2 | 0.5 | 0.7 | 0.74 | 0.39 | 1.52 | 0.95 | ND |
| Sn | ND | ND | ND | ND | ND | ND | ND | ND |
| Sr | 3188 | 3530 | 3458 | 3522 | 1992 | 0.28 | 0.05 | 1.83 |
| Ti | ND | ND | ND | ND | ND | ND | ND | ND |
| Tl | ND | ND | ND | ND | ND | ND | ND | ND |
| Zn | 1.32 | 0.19 | 0.11 | 0.11 | ND | ND | ND | ND |
| TSS | 131.3 | 221.67 | 53.33 | ND | | | | ND |
| NH3 | 130 | | | | | 82 | 16.6 | 15 |
| Methanol | 150 | | | | | | | ND |

ND - signifies that amount present was so small that the amount was not determinable

As illustrated by Table 5, a significant portion of the containments present in the raw water are no longer present in the effluent water from the ultrafiltration system (UF). For example, aluminum has been reduced from 3.29 mg/L to 0.67 mg/L, barium has been reduced from 6318 mg/L to 0.06 mg/l, calcium has been reduced from 13519 mg/L to a not determinable amount, iron has been reduced from 25.54 mg/L to a non-determinable amount, and etc. Unexpectedly, the influent water contained methanol which was removed by the pilot system 300. Accordingly, the pilot system 300 shows the effectiveness of one embodiment of a water treatment system as described.

Numerous other changes may be made which will readily suggest themselves to those skilled in the art and which are encompassed in the spirit of the disclosure. While various embodiments have been described for purposes of this disclosure, various changes and modifications may be made which are well within the scope of the present invention. Numerous other changes may be made which will readily suggest themselves to those skilled in the art and which are encompassed in the spirit of the disclosure.

What is claimed is:

1. A system for treating contaminated water to produce at least one of sodium hydroxide, hydrochloric acid, and sodium hypochlorite comprises:
a first coagulation tank configured to oxidize and coagulate effluent from waste water influent;
a first pH adjustment tank configured to adjust a pH of effluent from the first coagulation tank;
a first floc mix tank configured to add a first flocculant to effluent from the first pH adjustment tank;
an iron clarifier configured to separate iron from effluent from the first floc mix tank;
a second pH adjustment tank for adjusting the pH of effluent from the iron clarifier;
at least one multimedia filter configured to filter effluent from the second pH adjustment tank;
a first organics removal system configured to remove at least petroleum hydrocarbons from effluent from the at least one multimedia filter;
a first heat exchanger configured to heat effluent from the first organics removal system;
a third pH adjustment tank configured to adjust the pH of effluent from the first heat exchanger;
a softening clarifier configured to remove calcium carbonate and magnesium hydroxide sludge from effluent from the third pH adjustment tank;
a weak acid cation ion exchange column and a chelating ion exchange column configured to remove any remaining calcium and remaining magnesium to a level of less than 50 ppb from effluent from the softening clarifier;
a fourth pH adjustment tank configured to adjust the pH of effluent from the weak acid cation ion exchange column and the chelating ion exchange column;
a second floc mix tank configured to add a second flocculant to effluent from the fourth pH adjustment tank;
an aluminum clarifier configured to remove aluminum from effluent from the second floc mix tank.
a fifth pH adjustment tank configured to adjust the pH of effluent from the aluminum clarifier;
a membrane system configured to allow transport of ammonium ions across a semipermeable membrane into a cross flowing solution containing sulfuric acid to remove ammonium from effluent from the fifth pH adjustment tank;
an ammonia stripping tower configured to remove remaining ammonia from effluent from the membrane system;
a sixth pH adjustment tank configured to adjust the pH of effluent from the ammonia stripping tower;
a polishing tank configured to remove fluoride with using activated alumina from effluent from the sixth pH adjustment tank;
a filter configured to remove colloidal solids from effluent from the polishing tank;
a second organics removal system configured to remove at least one of organic acid and alcohol from effluent from the filter;
an evaporative brine concentrator configured to concentrate effluent from the second organics removal system, wherein effluent from the evaporative brine concentrator is a concentrated purified brine;
at least one electrolysis unit configured to convert the concentrated purified brine into at least one of sodium hydroxide, hydrochloric acid, and sodium hypochlorite,
wherein the system for treating contaminated water does not form any waste product that requires disposal in an EPA regulated Class II disposal well.

2. The system of claim 1, further comprising:
a waste water screening device configured to remove grit and particulates from the waste water influent before the first coagulation tank; and
at least one first equalization tank configured to equalizing flow pressure of effluent from the waste water screening device before the first coagulation tank.

3. The system of claim 2, further comprising:
a seventh pH adjustment tank configured to adjust the pH of effluent from the at least one first equalization tank;
an oil and water separator configured to remove oil from effluent from the seventh pH adjustment tank; and
at least one second equalization tank configured to equalize flow pressure of effluent from the oil and water separator and before the first coagulation tank.

4. The system of claim 1, further comprising:
an eighth pH adjustment tank configured to adjust the pH of effluent from the first organics removal system; and
a barium clarifier configured to remove barium sulfate from effluent from the eighth pH adjustment tank.

5. The system of claim 1, further comprising:
a strontium removal system for removing strontium from effluent downstream of the first organics removal system and upstream from the softening clarifier.

6. The system of claim 1, wherein the system for treating contaminated water further produces at least one of chlorine gas and iron chloride.

7. The system of claim 1, wherein the first organics removal system is selected from a group of an organo clay system and an ion exchange resin.

8. The system of claim 1, wherein the second organics removal system includes a liquid-liquid extraction system.

9. The system of claim 1, wherein the effluent water from the ammonia stripping tower has an ammonia concentration of less than 1 mg/l,
wherein the first organics removal system produces water with a total organic content of less than 140 mg/l and removes over 99% of BTEX,
wherein the softening clarifier removes total metals to levels below 100 ppb, and
wherein the second organics removal system produces water with the total organic content of 10 mg/l or less.

10. The system of claim 1, wherein the first pH adjustment tank adjusts the pH to a pH from 6.5 to 7.5,
wherein the second pH adjustment tank adjusts the pH to a pH from 4 to 6.5,
wherein the third pH adjustment tank adjusts the pH to a pH from 10.5 to 12,
wherein the fourth pH adjustment tank adjusts the pH to a pH of 6.5, and
wherein the sixth pH adjustment tank adjusts the pH to a pH from 8 to 10.5.

11. The system of claim 1, further comprising:
a calcium carbonate processing system that processes the calcium carbonate sludge removed from the softening clarifier to produce at least one of calcium carbonate, calcium oxide, and sodium carbonate.

12. A method for producing at least one of sodium hydroxide, hydrochloric acid, and sodium hypochlorite from contaminated water comprises:
removing iron from influent water to produce an iron reduced effluent;
removing petroleum hydrocarbons from the iron reduced effluent to produce a an organics reduced effluent;
removing at least one of calcium and magnesium from the organics reduced effluent to produce a softened effluent;
removing aluminum from the softened effluent to produce a clarified effluent;
removing ammonia from the clarified effluent to produce a purified brine;
treating the purified brine with cation and ion exchange resins to form a scale ion free brine;
polishing the scale ion free brine to produce a polished brine;
removing at least one of organic acid and alcohol from the polished brine to produce an organics reduced brine;
evaporating the organics reduced brine to produce a concentrated brine; and
treating the concentrated brine with electrolysis to produce at least one of sodium hydroxide, hydrochloric acid, and sodium hypochlorite.

13. The method of claim 12, wherein the method does not form any waste product that requires disposal in an EPA regulated Class II disposal well.

14. The method of claim 12, wherein the step of treating the concentrated brine with the electrolysis further produces chlorine gas.

15. The method of claim 14, further comprising:
processing the chlorine gas to produce iron chloride.

16. The method of claim 12, wherein the method further comprises:
removing oil from the influent water before the step of removing the iron from the influent water to produce the iron reduced effluent is performed.

17. The method of claim 12, further comprising:
removing barium from the organics reduced effluent and before performing the step of removing at least one of the calcium and the magnesium from the organics reduced effluent to produce the softened effluent.

18. The method of claim 12, further comprising:
removing strontium from the organics reduced effluent and before performing the step of removing at least one of the calcium and the magnesium from the organics reduced effluent to produce the softened effluent.

19. The method of claim 12, further comprising:
processing the calcium and the magnesium to produce at least one of calcium oxide and sodium carbonate.

20. A system for treating contaminated water to produce at least one of sodium hydroxide, hydrochloric acid, and sodium hypochlorite comprises:
a separated solids and iron removal system;
a first organics removal system adapted to remove at least petroleum hydrocarbons located downstream of the separated solids and iron removal system;
a soda softening system located downstream of the first organics removal system;
an aluminum removal system located downstream of the soda softening system;
an ammonia removal system located downstream of the aluminum removal system;
a polishing system located downstream of the ammonia removal system;
a second organics removal system adapted to remove at least one of organic acid and alcohol located upstream of a brine evaporation system and downstream from the first organics removal system;
the brine evaporation system located downstream of the polishing system and the second organics removal system; and
an electrolysis system located downstream of the brine evaporation system,
wherein the system is configured to produce at least one of sodium hydroxide, hydrochloric acid, and sodium hypochlorite.
